(19) United States
(12) Patent Application Publication
(10) Pub. No.: US 2026/0071115 A1
(43) Pub. Date: Mar. 12, 2026

(54) AQUEOUS NANOBUBBLE DISPERSION AND GAS SUPERSATURATION AT ELEVATED PRESSURES

(71) Applicant: Board of Regents, The University of Texas System, Austin, TX (US)

(72) Inventors: Ryosuke Okuno, Austin, TX (US); Francisco J. Argüelles-Vivas, Austin, TX (US); Chun Huh, Austin, TX (US); Tesleem Lawal, Allen, TX (US); Sofiane H. Achour, Austin, TX (US)

(73) Assignee: Board of Regents, The University of Texas System, Austin, TX (US)

(21) Appl. No.: 19/106,482

(22) PCT Filed: Aug. 28, 2023
(86) PCT No.: PCT/US2023/031257

§ 371 Date: Feb. 25, 2025

Related U.S. Application Data
(60) Provisional application No. 63/401,857, filed on Aug. 29, 2022.

(51) Int. Cl. C09K 8/92; C09K 8/84; E21B 41/00

(52) U.S. Cl. CPC C09K 8/92; C09K 8/84; E21B 41/0064

(57) ABSTRACT

Described are techniques for preparing dispersions of nanobubbles in aqueous fluids, such as water or brine, under high pressure in order to create dispersions with large amounts of one or more gases that are normally immiscible with the aqueous fluid. The composition of the aqueous fluids can be adjusted to contain an optimized amount of gas at the desired pressure conditions. The gas can be present in the dispersion both as an amount dissolved in the aqueous fluid and as the dispersed nanobubbles. A thermodynamic model may be used to determine the amounts of gas that can be present in the nanobubble dispersion and/or used to determine or optimize a composition for the fluid.

### CROSS-REFERENCE TO RELATED APPLICATIONS

This application claims the benefit of and priority to U.S. Provisional Application No. 63/401,857, filed on Aug. 29, 2022, which is hereby incorporated by reference in its entirety.

### FIELD

This application is in the field of nanobubble dispersions. Generally, the invention relates to techniques for supporting large amounts of water immiscible gases in an aqueous fluid by preparing aqueous nanobubble dispersions under high pressure conditions and techniques for preparing and optimizing such aqueous nanobubble dispersions.

### BACKGROUND

Many gases are immiscible with water. Adding or bubbling large amounts of such gases to or through water or other aqueous fluids generally does not result in dissolving amounts of such gases in excess of their solubility limits.

### SUMMARY

Described herein are techniques, including methods, for preparing dispersions of nanobubbles in aqueous fluids, such as water or brine, under high pressure in such a way that the dispersions can contain large amounts of one or more gases that are normally immiscible with the aqueous fluid. The composition of the aqueous fluids can be adjusted to contain an optimized amount of gas at the desired pressure conditions. The gas is present in the dispersion both as an amount dissolved in the aqueous fluid and an amount as the dispersed nanobubbles. In some examples, a relatively greater amount is present in a saturated or supersaturated solvated condition, and a relatively smaller amount is present as a stable dispersion of the nanobubbles. In other examples, a relatively smaller amount is present in a saturated or supersaturated solvated condition, and a relatively greater amount is present as a stable dispersion of the nanobubbles. The dispersion of nanobubbles in the aqueous fluid may be referred to herein as a nanobubble dispersion or an aqueous nanobubble fluid or aqueous NB fluid. A thermodynamic model may be used to determine the amounts of gas that can be present in the nanobubble dispersion (including in both dissolved and nanobubble form), with the thermodynamic model taking into account the composition of the fluid, the identity of the gas, and the conditions (e.g., temperature and pressure). The thermodynamic model can also or alternatively be used to determine a composition for the fluid, which can be adjusted or optimized to contain the amounts of gas in the nanobubble dispersion under a particular set of conditions (e.g., temperature and pressure). The nanobubble dispersions can be employed for a variety of uses, including for storage of gas in the aqueous nanobubble dispersions, for use in subterranean reservoirs (e.g., for enhanced oil recovery processes), as a fluid that contains large amounts of gas for use as a reactant in a chemical reaction or process (e.g., mineralization). Although any gas can be used in the techniques described herein, a particular advantage can be achieved for gases that are considered non-miscible in aqueous fluids like water or brine because the disclosed techniques can allow for large amounts of such non-miscible gases to be present in the aqueous fluid. In some cases, the dispersed nanobubbles are further useful for adjusting fluid properties of the aqueous fluid, such as the viscosity or density.

In an aspect, methods for preparing nanobubble dispersions are provided herein. In some examples, methods of this aspect may comprise determining a target composition of an aqueous fluid for use in a nanobubble dispersion of a gas at a specified temperature and a specified pressure; preparing the aqueous fluid according to the target composition; mixing a gas in the aqueous fluid to establish a supersaturated solution of the gas in the aqueous fluid at the specified temperature and the specified pressure; and subjecting the gas and the aqueous fluid to a bubble generation process to establish a dispersion of nanobubbles of the gas in the aqueous fluid at the specified temperature and the specified pressure.

As noted above, any suitable gas can be used, but in some examples, the gas is immiscible in the aqueous fluid or has a solubility in water of less than 2 g/L at standard temperature and pressure. In some cases, the solubility of the gas in water at standard temperature and pressure is less than or about 2 g/L, less than or about 1.75 g/L, less than or about 1.5 g/L, less than or about 1.25 g/L, less than or about 1 g/L, less than or about 0.75 g/L, less than or about 0.5 g/L, less than or about 0.25 g/L, less than or about 0.2 g/L, less than or about 0.15 g/L, less than or about 0.1 g/L, or less than or about 0.05 g/L. In some examples, the gas comprises CO₂, H₂, N₂, O₂, He, methane, ethane, ethylene, acetylene, propane, propylene, methylacetylene, cyclopropane, allene, butane, butylene, butyne, cyclobutane, butadiene, a hydrocarbon gas, or a combination of these. In some examples, the gas comprises a hydrocarbon gas suspended in or contained in an inert gas, a diatomic gas, or a gas with a low molecular weight (e.g., less than about 50 amu).

Any suitable temperature and pressure can be used for the specified pressure, though example methods include those where the process includes determining the composition for the aqueous fluid at the specified temperature and pressure and then establishing a dispersion of the nanobubbles in the aqueous fluid at that specified temperature and pressure. As noted above, the disclosed methods are especially useful with high pressures. In some examples, the specified pressure is from 1 MPa to 105 MPa, such as from 1 MPa to 5 MPa, from 5 MPa to 10 MPa, from 10 MPa to 15 MPa, from 15 MPa to 20 MPa, from 20 MPa to 25 MPa, from 25 MPa to 30 MPa, from 30 MPa to 35 MPa, from 35 MPa to 40 MPa, from 40 MPa to 45 MPa, from 45 MPa to 50 MPa, from 50 MPa to 55 MPa, from 55 MPa to 60 MPa, from 60 MPa to 65 MPa, from 65 MPa to 70 MPa, from 70 MPa to 75 MPa, from 75 MPa to 80 MPa, from 80 MPa to 85 MPa, from 85 MPa to 90 MPa, from 90 MPa to 95 MPa, from 95 MPa to 100 MPa, or from 100 MPa to 105 MPa. In some examples, the specified temperature is greater than 0° C. and less than a boiling point of the aqueous fluid at the specified pressure. In some examples, the specified temperature is greater than or about 0° C., greater than or about 10° C., greater than or about 20° C., greater than or about 30° C., greater than or about 40° C., greater than or about 50° C., greater than or about 60° C., greater than or about 70° C., greater than or about 80° C., greater than or about 90° C., greater than or about 100° C., greater than or about 110° C., greater than or about 120° C., greater than or about 130° C., greater than or about 140° C., greater than or about 160° C., greater than or about 160° C., greater than or about 170° C., or greater than or about 180° C.

The nanobubbles in the dispersion may range in sizes, but generally have diameters that are nano-scale, such as less than 1000 nm. In some examples, the nanobubbles have diameters from 1 nm to 1000 nm, such as from 1 nm to 25 nm, from 25 nm to 50 nm, from 50 nm to 75 nm, from 75 nm to 100 nm, from 100 nm to 150 nm, from 150 nm to 200 nm, from 200 nm to 250 nm, from 250 nm to 300 nm, from 300 nm to 350 nm, from 350 nm to 400 nm, from 400 nm to 450 nm, from 450 nm to 500 nm, from 500 nm to 600 nm, from 600 nm to 700 nm, from 700 nm to 800 nm, from 800 nm to 900 nm, or from 900 nm to 1000 nm. In some cases, at least a portion of the nanobubbles have charged surfaces, causing repulsive forces among them, and suppressing the small buoyant forces of the bubbles. In some cases, the nanobubble dispersions can be stable at the specified temperature and the specified pressure for a duration of up to 30 days, such as up to 1 day, up to 2 days, up to 5 days, up to 10 days, up to 14 days, up to 20 days, up to 25 days, or up to 30 days, or more.

The nanobubbles may provide the nanobubble dispersion with a large concentration of gas present in the aqueous fluid. For example, the dispersion of nanobubbles may correspond to a concentration of the gas in the aqueous fluid of from 0.05 mol/L to 20 mol/L, such as from 0.05 mol/L to 0.5 mol/L, from 0.5 mol/L to 1 mol/L, from 1 mol/L to 2 mol/L, from 2 mol/L to 3 mol/L, from 3 mol/L to 4 mol/L, from 4 mol/L to 5 mol/L, from 5 mol/L to 6 mol/L, from 6 mol/L to 7 mol/L, from 7 mol/L to 8 mol/L, from 8 mol/L to 9 mol/L, from 9 mol/L to 10 mol/L, from 10 mol/L to 11 mol/L, from 11 mol/L to 12 mol/L, from 12 mol/L to 13 mol/L, from 13 mol/L to 14 mol/L, from 14 mol/L to 15 mol/L, from 15 mol/L to 16 mol/L, from 16 mol/L to 17 mol/L, from 17 mol/L to 18 mol/L, from 18 mol/L to 19 mol/L, from 19 mol/L to 20 mol/L, or more. In some examples, an amount (e.g., a molar amount or a mass) of the gas dissolved or present in the aqueous fluid (e.g., present or dissolved in the aqueous phase, such as in the form of a supersaturated amount) in the dispersion of nanobubbles is greater than an amount of the gas in the nanobubbles (e.g., present in the gas phase as gas nanobubbles) in the dispersion of nanobubbles. Stated another way, the amount of the gas atoms or molecules may be higher in the liquid phase of the dispersion of nanobubbles than in the gase phase of the dispersion of nanobubbles. In other examples, an amount (e.g., a molar amount or a mass) of the gas dissolved or present in the aqueous fluid (e.g., present or dissolved in the aqueous phase, such as in the form of a supersaturated amount) in the dispersion of nanobubbles is less than an amount of the gas in the nanobubbles (e.g., present in the gas phase as gas nanobubbles) in the dispersion of nanobubbles. Stated another way, the amount of the gas atoms or molecules may be lower in the liquid phase of the dispersion of nanobubbles than in the gase phase of the dispersion of nanobubbles.

Advantageously, the presence of nanobubbles can impact or increase a supersaturation amount of the gas in the aqueous fluid. That is, when nanobubbles are present in the aqueous fluid as a dispersion, the aqueous fluid can support or contain a higher amount of the gas in a dissovled state than when the nanobubbles are absent from the aqueous fluid. Stated another way, the dispersion of nanobubbles can enhnance a supersaturation of the aqueous fluid by the gas. For example, the dispersion of nanobubbles of the gas in the aqueous fluid can exhibits a supersaturation amount greater than that of the supersaturated solution of the gas in the aqueous fluid (e.g., without the nanobubbles present). Further benefits can be achieved by the presence of the nanobubbles. For example, the dispersion of nanobubbles can increases an intensity and/or kinetics of mineral dissolution, carbonation, and/or precipitation in the subterranean reservoir to transform at least a portion of the gas to solid minerals in the subterranean reservoir. For example, when the gas is CO₂, the gas can undergo mineralization to form carbonate minerals.

A variety of aqueous fluids are useful with the methods described herein. In some examples, the aqueous fluid comprises water, seawater, reservoir resident water, produced water, river water, pond water, brine, engineered brine, or any combination of these. In examples, the aqueous fluid may be prepared by mixing one or more of the previously mentioned fluids and adding one or more soluble or insoluble components. For example, the aqueous fluid may comprise one or more salts, one or more electrolytes, one or more acids, one or more bases, a monovalent anion, a monovalent cation, a divalent anion, a divalent cation, a trivalent anion, a trivalent cation, formate, or any combination of these. Optionally, the aqueous fluid comprises an additive selected from surfactant, a foaming agent, a polymer, nanoparticles, an alcohol, an oxygenated solvent, or any combination of these. In some examples, the additive is present or dissolved in the aqueous fluid at a concentration of less than or about 3 wt. %, such as less than or about 2.5 wt. %, less than or about 2 wt. %, less than or about 1 wt. %, less than or about 0.5 wt. %, less than or about 0.25 wt. %, less than or about 0.2 wt. %, less than or about 0.1 wt. %, or 0 wt. %. However, the additive is optional, and in some examples the aqueous fluid does not comprise or include one or more additives selected from surfactant, a foaming agent, a polymer, nanoparticles, an alcohol, an oxygenated solvent, or any combination of these. Stated another way, in some examples, the aqueous fluid excludes one or more additives selected from surfactant, a foaming agent, a polymer, nanoparticles, an alcohol, an oxygenated solvent, or any combination of these.

Optionally, the step of determining the target composition of the aqueous fluid in some examples includes determining an ionic composition or ionic strength for the aqueous fluid. Optionally, the ionic strength may be from 0 mol/L to 6 mol/L, such as from 0 mol/L to 0.25 mol/L, from 0.25 mol/L to 0.5 mol/L, from 0.5 mol/L to 1 mol/L, from 1 mol/L to 1.5 mol/L, from 1.5 mol/L to 2 mol/L, from 2 mol/L to 2.5 mol/L, from 2.5 mol/L to 3 mol/L, from 3 mol/L to 3.5 mol/L, from 3.5 mol/L to 4 mol/L, from 4 mol/L to 4.5 mol/L, from 4.5 mol/L to 5 mol/L, from 5 mol/L to 5.5 mol/L, or from 5.5 mol/L to 6 mol/L. In some specific examples, the ionic composition comprises one or more ions selected from H⁺, Na⁺, K⁺, Mg²⁺, Ca²⁺, Fe²⁺, NH₄⁺, OH⁻, F⁻, Cl⁻, Br⁻, I⁻, SO₄²⁻, NO₃⁻, and CO₃²⁻, HCO₃⁻, PO₄³⁻, HCOO⁻, or any combination of these.

Optionally, determining the target composition of the aqueous fluid includes determining a target pH for the aqueous fluid. The pH may be any suitable pH, such as ranging from 1 to 14. Controlling a pH of the fluid may be useful for a variety of reasons. In some examples, the pH may impact a solubility of the gas in the aqueous fluid. In some examples, the pH may impact the thermodynamic condition or state within the aqueous fluid and also affect the amount of gas that can be dispersed as nanobubbles in the aqueous fluid.

Various bubble generation and mixing processes can be used in the methods of this aspect. In some examples, mixing the gas in the aqueous fluid and subjecting the gas and the aqueous fluid to a bubble generation process can be combined. Optionally, the bubble generation process comprises injecting the gas into the aqueous fluid through a porous membrane. Optionally, the bubble generation process comprises coinjecting the gas and the aqueous fluid through a porous membrane. Optionally, the bubble generation process comprises injecting the gas into the aqueous fluid using one or a plurality (e.g., an array) of nozzles, such as high velocity nozzles. Optionally, the bubble generation process comprises coinjecting the gas and the aqueous fluid together using one or a plurality (e.g., an array) of nozzles, such as high velocity nozzles. Optionally, the bubble generation process comprises subjecting the supersaturated solution of the gas in the aqueous fluid to a pressure reduction, at least temporarily, to initiate bubble nucleation. Optionally, the bubble generation process comprises subjecting the supersaturated solution of the gas in the aqueous fluid to ultrasonic energy to initiate bubble nucleation. Optionally, the bubble generation process comprises subjecting the supersaturated solution of the gas in the aqueous fluid to shear stress to initiate bubble nucleation.

In some examples, in methods of this aspect, determining the target composition of the aqueous fluid comprises providing at least the specified temperature, the specified pressure, and the identity of the gas to a thermodynamic model. The thermodynamic model may determine properties of the dispersion including an amount of the gas present in the dispersion as the nanobubbles or the amount of gas supported in the dispersion as nanobubbles. Determining the target composition of the aqueous fluid may comprise or further comprises providing the thermodynamic model with identities of one or more salts, one or more electrolytes, one or more acids, one or more bases, or one or more additives for use in the aqueous fluid. The thermodynamic model may evaluate characteristics of the nanobubble dispersion, such as interfacial tension at a given capillary pressure with net zero mass transfer across the curved interfaces of the nanobubbles, treating the nanobubble dispersion as a closed system. Optionally, the thermodynamic model uses empirical data determined by preparing test nanobubble dispersions under fixed temperature, pressure, and aqueous fluid composition conditions and evaluating an amount of gas present in the test nanobubble dispersions. Such empirical data can be used to adjust or calibrate the thermodynamic model.

As noted above, the nanobubble dispersions are useful for a variety of applications. In some examples, methods of this aspect may comprise or further comprise injecting the dispersion of nanobubbles into a subterranean reservoir. Optionally, the dispersion of nanobubbles may be produced from the subterranean reservoir, such as after injection. In some examples, injecting the dispersion of nanobubbles into the subterranean reservoir comprises or is useful for storing the gas in the subterranean reservoir as the dispersion of nanobubbles. In this way, large amounts of gas can be stored in reservoirs containing aqueous fluids. For example, hydrogen gas (H₂) can be efficiently stored in a subterranean reservoir according to the disclosed methods. Storage of hydrogen gas according to the disclosed techniques can optionally be augmented with other storage techniques, such as where hydrogen gas is stored in another chemical form, such as in the form of a carboxylate (e.g., formate) as described in PCT International Application No. PCT/US2022/027116, filed on Apr. 29, 2022, which is hereby incorporated by reference.

Optionally, the dispersion of nanobubbles is subjected to a mineralization process in the subterranean reservoir to transform at least a portion of the gas to a solid mineral in the subterranean reservoir. For example, a dispersion of CO₂ nanobubbles in an aqueous fluid can be injected into a subterranean reservoir for purposes of carbon sequestration. In some cases, the CO₂ dissolved in the aqueous fluid and/or present as nanobubbles in the aqueous fluid can be mineralized at a relatively high rate due to the high amount of CO₂ available in the aqueous fluid. Optionally, a composition of the aqueous fluid can be controlled or optimized to support high or higher rates of CO₂ mineralization, such as when subjected to the temperature and pressure conditions within a subterranean reservoir. Storage/sequestration of carbon according to the disclosed techniques can optionally be augmented with other storage techniques, such as where carbon is stored in another chemical form, such as in the form of a carboxylate (e.g., formate) as described in PCT International Application No. PCT/US2022/027116, filed on Apr. 29, 2022.

In specific examples, the present disclosure also provides carbon sequestration methods. In some examples, the above disclosed methods can be used for carbon sequestration, such as when the gas comprises a carbonaceous material (e.g., a hydrocarbon or CO₂). An example carbon sequestration method comprises preparing an aqueous fluid for use in a nanobubble solution of CO₂ in a subterranean reservoir; mixing CO₂ in the aqueous fluid to establish a supersaturated solution of the CO₂ in the aqueous fluid; subjecting the supersaturated solution to a bubble generation process to establish a dispersion of nanobubbles of the CO₂ in the aqueous fluid, wherein the dispersion of nanobubbles of the CO₂ in the aqueous fluid exhibits a supersaturation amount greater than that of the supersaturated solution of the CO₂ in the aqueous fluid; and injecting the dispersion of nanobubbles of the CO₂ in the aqueous fluid into the subterranean reservoir, wherein the dispersion of nanobubbles of the CO₂ in the aqueous fluid is subjected to a mineralization process in the subterranean reservoir to transform at least a portion of the CO₂ injected into the subterranean reservoir to a carbonate mineral in the subterranean reservoir. In some examples, the dispersion of nanobubbles of the CO₂ in the aqueous fluid exhibits a higher intensity and/or faster kinetics of mineral dissolution, carbonation, and/or precipitation than the supersaturated solution of the CO₂ in the aqueous fluid.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1A shows a schematic illustration of a volume of an aqueous fluid that contains a saturated or supersaturated amount of a gas.

FIG. 1B provides a schematic illustration of a volume of an aqueous nanobubble dispersion, comprising a plurality of nanobubbles of a gas dispersed in an aqueous fluid at a specified temperature and pressure.

FIG. 2 provides an overview of an example method of preparing and using an aqueous nanobubble dispersion.

FIG. 3A and FIG. 3B provide sample calculations of phase equilibrium for the N₂-water binary system at 297 K with a bubble radius of 10 nm using the Peng-Robinson equation of state.

FIG. 4 provides a plot of interfacial tension between the external water phase and the gas bubbles for varying radius of the bubbles.

FIG. 5 provides a calculation example in which the energy released by a phase split is equal to the energy required for the bubbles to create the interfacial area in the system.

FIG. 6 provides a schematic of an experimental setup for gas content measurement.

FIG. 7 provides results of N₂ gas content measurements.

FIG. 8 provides mass densities of the aqueous nanobubble fluids.

FIG. 9 provides a schematic of an experimental setup for stability evaluation.

FIG. 10 provides photos of sapphire cells that contain aqueous nanobubble fluids at approximately 1800 psig at room temperature: (FIG. 10A) without N₂ gas cap, (FIG. 10B) with N₂ gas cap.

FIG. 11 provides a schematic of an experimental setup for apparent viscosity measurement.

FIG. 12 provides differential pressures during the apparent viscosity measurement for an aqueous nanobubble fluid with brine and N₂ using a Berea sandstone core.

FIG. 13 provides plots showing equilibrium mole fractions of water in the vapor phase and nitrogen in the aqueous phase.

FIG. 14 provides a plot showing calibrated pseudo-covolume for water/N₂.

FIG. 15 provides a plot showing calibrated Parachor model for interfacial tension of water and nitrogen at various temperatures and pressures.

FIG. 16 provides a plot showing the temperature-dependent coefficient χ for a modified Parachor model.

FIG. 17 provides a schematic overview of an experimental setup used to generate aqueous nanobubble fluids.

FIG. 18 provides a schematic overview of an experimental setup to measure the thermodynamic properties of aqueous nanobubble fluids.

FIG. 19 provides plots showing solutions of a thermodynamic equilibrium model for example aqueous nanobubble fluid samples.

FIG. 20 provides plots showing reduced total Helmholtz free energies for example aqueous nanobubble fluid samples.

FIG. 21 provides plots showing mass of water, bubble radius, bubble number density, N₂ content, fraction of N₂ in bubbles, interfacial area, interfacial tension, and capillary pressure of N₂ in water for example aqueous nanobubble fluid samples.

FIG. 22 provides a flow chart providing an overview of an algorithm for an example flash calculation.

### DETAILED DESCRIPTION

Described herein are techniques for preparing dispersions of nanobubbles in aqueous fluids, such as water or brine, under high pressure in order to create dispersions with large amounts of one or more gases that are normally immiscible with the aqueous fluid. The composition of the aqueous fluids can be adjusted to contain an optimized amount of gas at the desired pressure and temperature conditions. The gas can be present in the dispersion both as an amount dissolved in the aqueous fluid and as the dispersed nanobubbles. A thermodynamic model may be used to determine the amounts of gas that can be present in the nanobubble dispersion and/or used to determine a composition for the fluid.

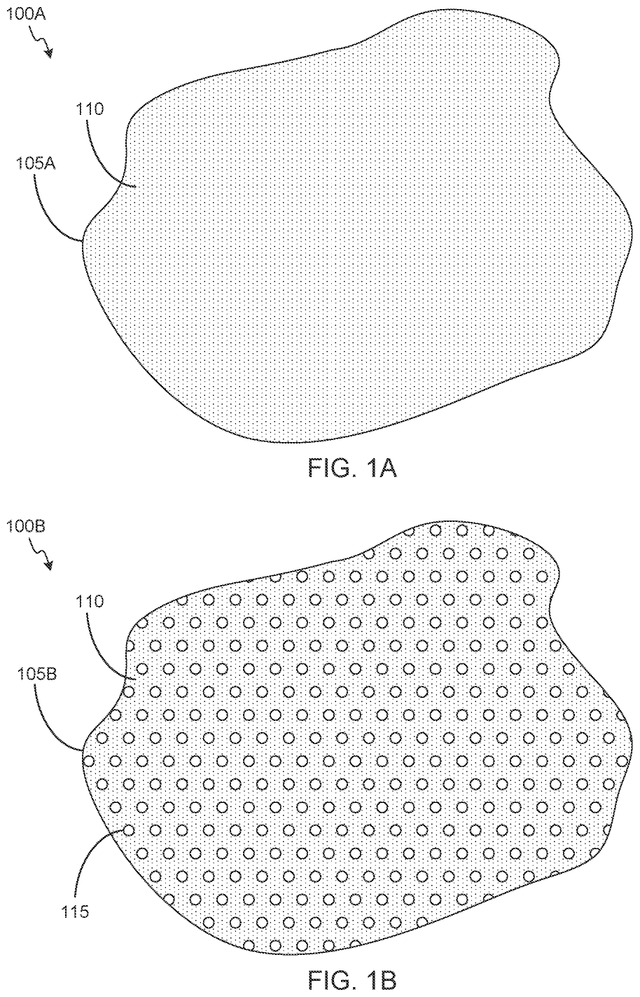

FIG. 1A shows a schematic illustration of a volume 105A of an aqueous fluid 110 which contains a saturated or supersaturated amount of a gas, such as an immiscible gas or a gas with a low solubility limit (e.g., less than 2 g/L at standard temperature and pressure). The aqueous fluid 110 can be water, brine or any other suitable aqueous fluid, such as fresh water, seawater, reservoir resident water, produced water, river water, pond water, brine, engineered brine, or any combination of these. The aqueous fluid 110 can include any suitable composition, such as including one or more salts, one or more electrolytes, one or more acids, one or more bases, a monovalent anion, a monovalent cation, a divalent anion, a divalent cation, a trivalent anion, a trivalent cation, formate, or any combination of these. Specific example ions present in the aqueous fluid 110 include, but are not limited to, H⁺, Na⁺, K⁺, Mg²⁺, Ca²⁺, Fe²⁺, NH₄⁺, OH⁻, F⁻, Cl⁻, Br⁻, I⁻, SO₄²⁻, NO₃⁻, and CO₃²⁻, HCO₃⁻, PO₄³⁻, HCOO⁻, or any combination of these. Optionally, aqueous fluid 110 can include one or more additives, such as surfactant, a foaming agent, a polymer, nanoparticles, an alcohol, or an oxygenated solvent, in an amount up to about 3 wt. %, but in some examples, such materials are not present in or are excluded from aqueous fluid 110. In some examples, the ionic strength of the aqueous fluid 110 can be from 0 mol/L to 6 mol/L. In some examples, the aqueous fluid 110 can have any suitable pH, such as from 1 to 14.

FIG. 1B provides a schematic illustration of a volume 105B of an aqueous nanobubble dispersion, comprising a plurality of nanobubbles 115 of a gas dispersed in aqueous fluid 110 at a specified temperature and pressure. In examples, the specified pressure is from 1 MPa to 105 MPa. In examples, the specified tempreature is between 0° C. and a boiling point of the aqueous fluid 110 at the specified pressure. It will be appreciated that the depiction of the plurality of nanobubbles 115 is merely a two-dimensional illustration and that nanobubbles present in an aqueous nanobubble dispersion may include different sizes, numbers, number densities, or distributions of the nanobubbles throughout the dispersion. In examples, the nanobubbles 115 can have diameters ranging from 1 nm to 1000 nm. The aqueous nanobubble dispersion may correspond to a concentration of the gas in the aqueous fluid 110 of from 0.05 mol/L to 20 mol/L, for example.

Example gasses include, but are not limited to CO₂, H₂, N₂, O₂, He, methane, ethane, ethylene, acetylene, propane, propylene, methylacetylene, cyclopropane, allene, butane, butylene, butyne, cyclobutane, butadiene, a hydrocarbon gas, or a combination of these. In some cases, amounts of hydrocarbons that have low vapor pressures can be suspended or distributed in a low molecular weight or inert gas to provide that hydrocarbon as a portion of the gas in nanobubble form in the aqueous nanobubble dispersion.

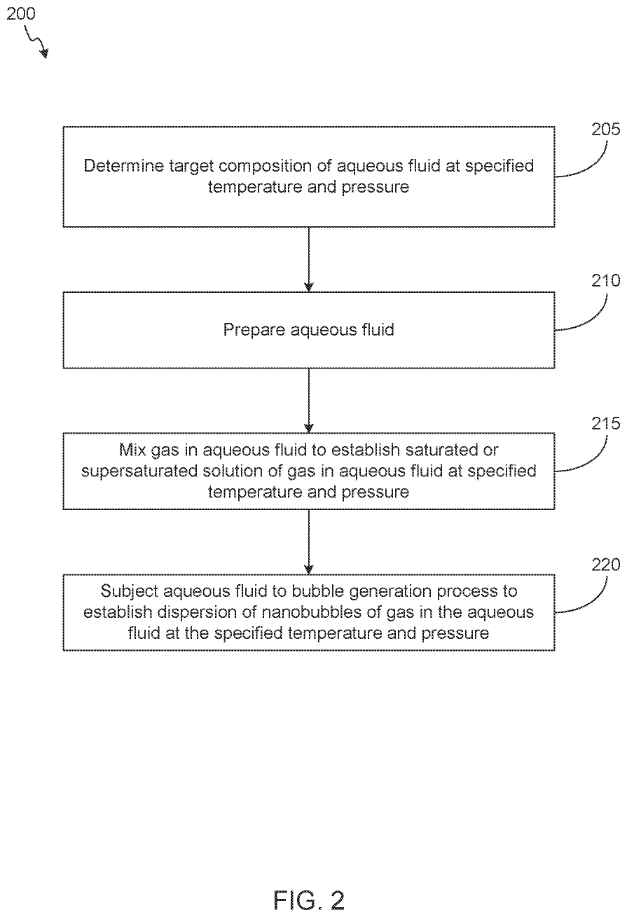

Various techniques can be used to prepare the aqueous nanobubble dispersions described herein. For example, FIG. 2 provides an overview of an example method 200 of preparing and using an aqueous nanobubble dispersion. Method 200 includes, at block 205, determining a target composition of the aqueous fluid. This may include determining a specified temperature and pressure for the aqueous fluid. The specified temperature and pressure may correspond, in some cases, to a temperature and pressure in a subterranean reservoir, for example. Determining the composition of the aqueous fluid may comprise, in some examples, providing information about the aqueous fluid and/or the gas to be dispersed therein to a thermodynamic model. For example, the temperature, pressure, fluid components (e.g., identities of salts, electrolytes, anions, etc.), gas identity (including gas mixtures), or the like may be provided as inputs to the thermodynamic model. The thermodynamic model may determine or provide an amount of the gas that can be dispersed in the aqueous fluid in the form of nanobubbles and/or dissolved gas. The thermodynamic model may determine the composition of the aqueous fluid, such as amounts or identies of one or more salts, one or more electrolytes, one or more acids, one or more bases, or one or more additives for use in the aqueous fluid. The thermodynamic model may evaluate characteristics of the nanobubble dispersion, such as interfacial tension at a given capillary pressure with net zero mass transfer across the curved interfaces of the nanobubbles, treating the nanobubble dispersion as a closed system. Optionally, the thermodynamic model uses empirical data determined by preparing test nanobubble dispersions under fixed temperature, pressure, and aqueous fluid composition conditions and evaluating an amount of gas present in the test nanobubble dispersions. Such empirical data can be used to adjust or calibrate the thermodynamic model.

In some examples, the thermodynamic model is provided or used as a software package or algorithm, such as where the inputs to the thermodynamic model (e.g., temperature, pressure, gas identity, aqueous fluid component identities, etc.) are input into the software package or algorithm and amounts of gas and/or identities and amounts and/or identies of one or more salts, one or more electrolytes, one or more acids, one or more bases, or one or more additives for use in the aqueous fluid are output.

At block 205, method 200 includes preparing the aqueous fluid. The aqueous fluid may be prepared by mixing water, brine or any other suitable aqueous fluid, such as fresh water, seawater, reservoir resident water, produced water, river water, pond water, brine, engineered brine, or any combination of these with appropriate amounts of one or more salts, electrolytes, acids, bases, monovalent anions, monovalent cations, divalent anions, divalent cations, trivalent anions, trivalent cations, and optionally a surfactant, a foaming agent, a polymer, nanoparticles, an alcohol, or an oxygenated solvent.

At block 215, method 200 includes mixing the gas in the aqueous fluid to establish a saturated or supersaturated solution of the gas in the aqueous fluid, at the specified temperature and pressure. In some examples, the gas may be mixed in the aqueous fluid by bubbling the gas through the fluid, at the specified temperature and pressure, or at other temperature and/or pressure conditions and then returning the fluid to the specified temperature and pressure.

At block 220, method 200 includes subjecting the aqueous fluid to a bubble generation process. The bubble generation process may establish a dispersion of nanobubbles of the gas in the aqueous fluid at the specified temperature and pressure. Various techniques for the bubble generation process may be used, several of which may optionally also be used for the mixing step of block 215. In some examples, the bubble generation process comprises injecting the gas into the aqueous fluid through a porous membrane or through a nozzle or array of nozzles. In some examples, the bubble generation process comprises coinjecting the gas and the aqueous fluid through a porous membrane or coinjecting the gas and the aqueous fluid through a nozzle or array of nozzles. In some examples, the use of a nozzle or array of nozzles may be useful for generation of bubbles downhole in a well, such as at, adjacent to, or into a subterranean reservoir. Optionally, the bubble generation process comprises subjecting the supersaturated solution of the gas in the aqueous fluid to a pressure reduction, at least temporarily, to initiate bubble nucleation. In some cases, the pressure reduction can correspond to changing the pressure from a value above the specified pressure to a value matching the specified pressure.

In some examples, method 200 can include various other steps. For example, method 200 can include a step of injecting the nanobubble dispersion into a subterranean reservoir. In some examples, method 200 can comprise a method for carbon sequestration, such as where the nanobubble dispersion comprises a dispersion of CO₂ in the aqueous fluid. In some examples, the nanobubble dispersion can be used to store amounts of the gas in a subterranean reservoir for later retrieval. Accordingly, method 200 can optionally include a step of producing the nanobubble dispersion from the subterranean reservoir after injection. In some examples, method 200 may comprise a method of storing an energy containing gas (e.g., H₂, CH₄, natural gas, air, etc.) as an aqueous nanobubble dispersion in a subterranean reservoir. In some cases, the nanobubble dispersion is used as a composition for enhanced oil recovery. Accordingly, method 200 can optionally include a step of producing a hydrocarbon-containing fluid from the subterranean reservoir after injection.

The invention may be further understood by the following non-limiting examples.

### Example 1

Many gaseous species, such as CO₂, H₂, N₂, and light hydrocarbons, are highly immiscible with water, and their equilibrium concentrations in aqueous fluid (e.g., water or brine) are often quite small under a wide range of conditions. However, various industrial processes will benefit if these immiscible gaseous species can be contained in the aqueous fluid as an effectively homogeneous phase.

The present disclosure provides techniques enabling efficient generation of such aqueous fluids that can contain a large amount of an immiscible gas or gas mixture at elevated pressure in a controlled and scalable manner. Advantageously, the gaseous species can be stably dispersed in the aqueous fluid as small bubbles, typically at a nano-meter scale, and dissolved molecules of gas in the aqueous fluid. These two modes of containment can collectively make the overall concentration of the gaseous species orders of magnitude greater than its thermodynamic solubility in the aqueous fluid. Such aqueous fluid with gas-bubble/molecule dispersion is referred to as “aqueous NB fluid” in this and the subsequent examples.

Aspects of this process may include the following general steps:
Step 1. Specifying operating conditions, such as temperature, pressure, aqueous fluid composition, gaseous species, a mixing method, a bubble-generation method, or the like.
Step 2. Mixing the gaseous species and the aqueous fluid at the specified conditions.
Step 3. Generating bubbles of the gaseous species in the aqueous fluid at the specified conditions. This bubble-generation step can optionally be combined with the mixing step above.
Step 4. Stabilizing the resulting fluid as a closed system at the specified conditions (e.g., temperature and pressure). As needed, the bulk gas phase caused by the excess amount of the gaseous species is displaced from the system for recycling so that the aqueous phase can contain the gaseous species as dispersion of stable bubbles and dissolved molecules.

In step 1, in some examples, the temperature can be greater than 273 K and lower than the boiling temperature of the aqueous fluid at the specified pressure. The pressure is generally greater than atmospheric pressure since there is an advantage in achieving a substantial increase in gas containment with pressure. The aqueous fluid can be water or naturally occurring brine or engineered brine with a specific ionic composition and/or any additives for an optimized application. Although foaming agents, such as polymers and surfactants, are not required, these or other electrolytes can be optimized as needed so that the gas containment can be enhanced. The gaseous species can be a single-component gas or gas mixture, which is not miscible with the aqueous fluid. Step 1 can employ software or algorithms that calculate the resulting properties of the gas-containing aqueous fluid for the specified conditions. The software can use computational algorithms based on thermodynamics and thermodynamic models, and optionally experimental data/correlations.

In step 2, in some examples, the mixing method is to induce the (super)saturation of the aqueous fluid by the gaseous species at the operating conditions. The concentration of the gaseous species in the aqueous fluid can be useful for step 3, in which gas bubbles should be stably dispersed in the aqueous fluid.

Different methods are available for step 3 for low-pressure conditions, but an efficient, simple method for high-pressure applications is to use a porous membrane (e.g., ceramic and/or stainless steel). When a porous membrane is used for step 3, the injection rates of the gaseous species and the aqueous fluids should be designed for a given membrane with known properties. The injection rates (and their ratio) can substantially affect the amount of the gaseous species in the aqueous fluid, and therefore physical and transport properties of the resulting fluid. The permeability, porosity, material, water-gas relative permeabilities should be known for the membrane used and can be adapted in the thermodynamic model, for example. It will be appreciated that other techniques for generating bubbles can be used and that use of a porous membrane is not intended to be limiting. In other examples, bubble generation can be achieved using any suitable techniques, such as cavitation, application of ultrasonic energy, pressure reduction of the supersaturated aqueous phase, application of shear stress to the supersaturated aqueous phase, subjecting the supersaturated aqueous phase to turbulent conditions, or the like. Various properties, flow conditions, or the like can affect the number density of bubbles, the level of gas supersaturation in the aqueous phase, the bubble size, and the total gas concentration through the hydrodynamic mixing, gas snap-off, gas nucleation in the convective flow of two immiscible phases (gas and water) in the porous membrane, or the like, such as gas and liquid injection rates for a given porous membrane, liquid flow rate, pressure, container dimensions and dimensional changes, etc.

A goal of the process is to make a thermodynamically stable state under the desired conditions (e.g., temperature and pressure) in a closed system with a gas-supersaturated aqueous phase and dispersed gaseous bubbles. The two phases should be prepared to be stable with the specified thermodynamic conditions in a closed system, in which bubbles of a large number density are contained in the continuous aqueous phase with an interfacial tension at a given capillary pressure with net zero mass transfer across the curved interfaces. For some situations, most of the gas will be in the form of bubbles with the rest in the form of molecularly dissolved gas in the aqueous phase. This may occur, for example, when the gas is highly immiscible with water, but need not be the case in all examples. For other situations, in the aqueous NB fluid, most of the gas will be in the form of molecularly dissolved gas in the aqueous phase with the rest in the form of bubbles. This can occur even if the gas is generally considered immiscible or highly immiscible with water. In some examples, having nanobubbles present or suspended in the aqueous phase can be useful for generating supersaturated conditions. The nano-scale bubbles can have charged surfaces, causing repulsive forces among them, and suppressing the small buoyant forces of the bubbles. The upper limit of nanobubble number density for given operating conditions for a stable aqueous NB fluid can be estimated by the software or algorithm, in some examples.

In general, it is less stable if the system contains the bulk gas phase; that is, it is more desirable to employ step 4, where the excess gas is removed. The overall gas concentration in the aqueous fluid so prepared will be greater as the pressure increases. Therefore, even when operated at low pressure and open to the atmosphere, the generation of aqueous NB fluid will be more effective. Such a low-pressure application may experience the reduction of the gas content in the fluid over time and by any changes in thermodynamic variables.

Industrial processes. The techniques described in this example can make the immiscible gaseous species stably dispersed as bubbles and dissolved molecules in the aqueous fluid. The system needs to be a closed system for the stability of the aqueous NB fluid when it is prepared. By taking advantage of pressure, the current invention finds its most promising applications in subsurface processes and high-pressure surface processes that are mediated by aqueous fluids.

High-pressure surface processes, which can be benefited from the disclosed techniques, include CO₂ electrochemical reaction processes and any other reactions that require a high concentration of the gas species as a reactant. Aqueous NB fluids can be used for high-pressure storage of gases, such as H₂, in tanks, pipes, and other pressure vessels. Some surface processes do not require long-term stability of nanobubbles since they use the gaseous species for reactions (consumption); therefore, such processes can optionally be given the aqueous NB fluid with a greater amount of gas than other processes, such as long-term gas storage.

The subsurface applications include enhanced oil recovery (EOR) by gas injection and geological storage of gases in hydrocarbon reservoirs and aquifers. Typical gases used in EOR are light hydrocarbons (e.g., methane, ethane, and propane), CO₂, and N₂; typical gases for geological storage are light hydrocarbons, CO₂, H₂, helium, air, and N₂. These applications include energy storage as compressed gas based on renewable energy sources, which are sometimes intermittent and require short-term storage.

In gas EOR, the injected gas not only quickly passes through high-permeability layers and/or fracture networks, but also gravity-segregates to the upper zones of the target reservoir. Such undesired flow regimes result in a rapid breakthrough of the injected gas to production wells, leading to a poor volumetric sweep efficiency and costly recycling of the injection gas. To alleviate the problem, water-alternating-gas (WAG) injection is commonly employed; however, the water and gas can quickly segregate, losing its effectiveness. A low concentration of specially formulated surfactant can be added to the water so that a surfactant-stabilized gas foam bank is generated. With the high apparent viscosity of foam phase, a better mobility control of the gas injection is expected. However, two main weaknesses of such gas foam technologies are (i) the stability of foam flowing in reservoir pores is difficult to control, and (ii) the use of surfactant adds the complexity and cost of the field operations.

The aqueous NB fluids and associated processes described herein can effectively reduce the mobility of the injected gas since it flows with the external aqueous phase as the carrier, with no risk of gas bubbles being trapped at rock pores. The apparent viscosity of the aqueous NB fluid is shown to be slightly greater than the external phase alone with no nanobubbles. Therefore, the mobility of the gaseous species contained in the aqueous NB fluid is reduced substantially, by a factor of 10 in the experimental case with a Berea sandstone core, in comparison to two-phase simultaneous flow with relative permeabilities. The reduced mobility of gaseous species is beneficial both for EOR and gas storage applications.

The aqueous NB fluids prepared according to the disclosed techniques contain the gaseous species as bubbles at the nano scale and can flow like ordinary brine or other aqueous fluids in geological formations. The dispersion of nanobubbles can substantially suppress the buoyant forces in comparison to when the gas was injected as a bulk gas phase in the presence of water. Also, use of aqueous NB fluids can reduce the density difference between the injected fluid and the reservoir oil in comparison to the conventional gas injection. For example, the mass density of aqueous NB fluid can be close to that of the reservoir oil to be displaced.

When the aqueous NB fluid and processes described herein are applied for geological CO₂ sequestration, they can substantially enhance the kinetics of carbon mineralization for robust carbon sequestration, for example. Along with the mineralization, the reduced buoyant forces due to the containment of CO₂ as nanobubbles in the brine can mitigate the potential leakage of CO₂ to the surface through any hydraulic paths (e.g., faults and old wells).

Many biogenic gas reservoirs can be used for CO₂ sequestration, but contamination of the reservoir gas by the injected CO₂ is a major concern. Using the current invention, the mixing of CO₂ and natural gas (mainly methane) can be controlled by containing the CO₂ in the injected aqueous phase.

In some examples, the gas nanobubbles can be generated not just in aqueous fluids (e.g., water or brine) but also in aqueous solutions of other chemicals. Thus, the rheology and/or density of the drilling fluids, fracturing fluids, and completions cement can be controlled or adjusted by including nanobubbles in these fluids.

Also, a combination of the CO₂ sequestration and the storage of formate (HCOO⁻ dissolved in water) may bring added benefits. Use of carboxylates for carbon sequestration, EOR, and hydrogen storage is described in PCT International Application No. PCT/US2022/027116, filed on Apr. 29, 2022, which is hereby incorporated by reference. In examples, carboxylate containing fluids may be modified to include nanobubbles of CO₂ to enhance the carbon sequestration ability of the fluid. In examples, carboxylate containing fluids may be modified to include nanobubbles of H₂ to enhance the hydrogen storage capacity of the fluid.

There are applications of gas bubbles in food, agriculture, wastewater treatment, mineral processing, pharmaceutical, and other industries. However, these previous applications are limited primarily to atmospheric pressure, in which the bubbled water is generated in an open system near atmospheric pressure. Such bulk aqueous bubble systems tend to be unstable at a large bubble number density without continuous addition of energy. As explained above, aqueous NB fluids can be generated with a significantly greater amount of the gaseous species at elevated pressure, and it finds more useful applications at elevated pressures. Further, use of nano-scale bubbles provides advantages in that the bubbles can remain dispersed in the aqueous fluid, which is generally not the case with larger-scale bubbles which are applied in many conventional systems. Previously, however, no method had been found to control and design the physical and transport properties of such gas-containing fluids at high pressures. This example and the present disclosure achieve this, at least in part, by obtaining a fundamental understanding of the thermodynamics involved in stable aqueous NB fluid formation and through the use of software and algorithms embodying such understanding. Further, use of an experimentally determined database of measurements can enhance performance and predictive abilities of the thermodynamic model.

The current technology is useful for generation and industrial applications of a large number of bubbles that coexist with the gas-supersaturated external water phase in a closed system. From the thermodynamic point of view, this is quite different from a single bubble or multiple bubbles in an open system at low pressure.

Sample data and results. Stability of aqueous NB fluid. Theoretical understanding of bubble stability is beneficial for the disclosed techniques. Algorithms and software to perform such algorithms involving thermodynamic calculations of fluid phases with curved interfaces, including gas bubbles in aqueous fluid have been developed. The algorithms and software are useful for exploring a fundamental understanding of various factors affecting the formation of aqueous NB fluids and for determining optimal or beneficial fluid formulations for supporting stable nanobubble dispersions.

A theoretical framework for phase stability analysis has been established, following from Gibbs' original work, but there has been no rigorous solution to the phase stability problem in the presence of capillary pressure. Therefore, fundamental changes were employed for a theoretical formulation by using the Helmholtz free energy, instead of the Gibbs free energy, for phase stability and equilibrium calculations under capillary pressure. The inherent consistency between the Helmholtz and Gibbs free energy has been confirmed and validates the new framework developed here.

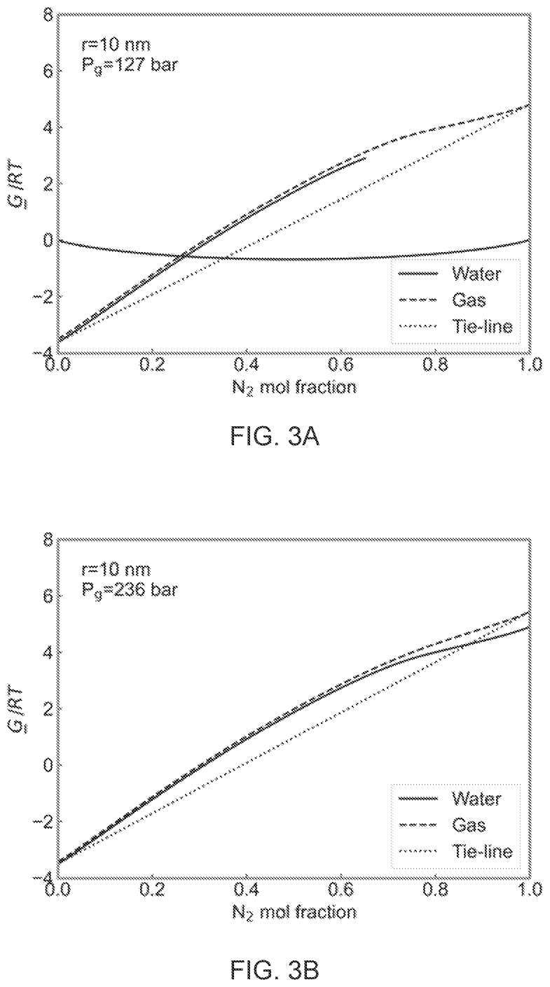

The thermodynamic model can estimate properties of aqueous NB fluids at a given thermodynamic conditions (e.g., component mole numbers, temperature, and volume), such as phase compositions, bubble size, and phase amounts, assuming the stability of individual bubbles. FIG. 3A and FIG. 3B show sample calculations of phase equilibrium for the water-N₂ binary system at two different pressures (FIG. 3A: 1.01 bar and FIG. 3B: 140 bar) at 298 K with a bubble radius of 10 nm. The solution was evaluated by minimization of the Helmholtz free energy using the associated algorithms, but for clarity, the results are shown in terms of the Gibbs free energy. The figures show that the displacement of the Gibbs free energy surface at the gas-phase pressure is more significant at the bulk pressure of 1.01 bar (FIG. 3A), because the relative magnitude of the gas-phase pressure to the bulk pressure is more significant when the bulk pressure is lower. This highlights one advantage part of techniques described herein, where high-pressure conditions are focused on, as compared to previous techniques at ambient pressure.

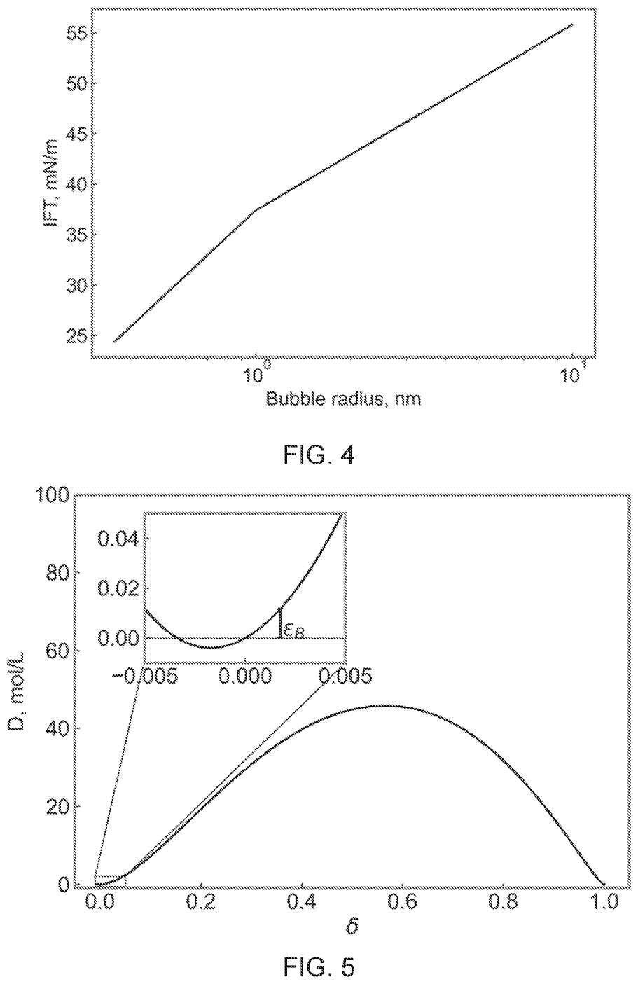

Previous studies speculated that the interfacial tension between the external water phase and the gas bubbles depends on the size of the bubbles. The software and associated algorithms established for the techniques described herein naturally predicts the size-dependent interfacial tension because of the predicted relationships among variables, such as phase compositions, pressures, surface area, and interfacial tension, as shown in FIG. 4. This figure was made by changing the bubble size for the water-N₂ binary example shown in FIG. 3B.

When the aqueous NB fluid is formed from a gas-supersaturated water, a sufficient amount of energy is available for the interfacial area required for the bubbles contained in the external water phase in the system. When the system is set at a given temperature and total volume, the Helmholtz free energy of the gas-supersaturated single-phase fluid for the mixture is reduced to that of the aqueous NB fluid consisting of two phases (the external water phase and gas bubbles). Theoretically, the Helmholtz free energy obtained by the phase split is used to form the interfacial area for the bubbles. FIG. 5 shows an example calculation where the amount of the Helmholtz free energy released by forming the aqueous NB fluid is equal to the energy required to cause the interfacial area of the bubbles in the system. In reality, however, any dissipation will demand an excess amount of the energy beyond the theoretically required amount of energy. Therefore, the theoretical framework can be supplemented by experimental data, as shown in the next subsection.

Since the aqueous NB fluid in the current technology involves the gas-supersaturated aqueous phase at equilibrium with the gaseous bubbles, it is useful for the thermodynamic model to be reliable in the metastable region. The example calculations shown in this section use the Peng-Robinson equation of state (EOS), but other models, such as the GERG-2008 EOS, can be used with no fundamental change to the method.

When the aqueous NB fluid contains many bubbles, the stability of multiple bubbles is indicated by the upper limit in number density of bubbles (the number of bubbles within the unit volume). This maximum number density depends partly on molecular-level details near the interfaces, which are not easy to quantitatively predict for general realistic conditions. In some cases, the number density can be estimated by supplementing with a database of experimentally determined information to provide guideposts to the values generated using the thermodynamic model, such as to apply a calibration or correction factor to the modeled values.

Gas content measurement. The amount of the gaseous species in the aqueous NB fluid is referred to as “gas content” in this example. It is one of the most fundamental data and substantially affects various applications of the technology, such as geological CO₂ sequestration. A database of the gas content for a wide range of conditions is useful, not only because it is not easy to quantitatively predict it using a theoretical model, but also because it depends on the mixing and bubble-generation methods (steps 2 and 3). When step 3 uses a porous membrane, for example, the gas content depends on the injection rates of gas and water for a given set of conditions (pressure, temperature, fluids' compositions, properties of the porous membrane, etc.). The gas content measurement is described below for a set of conditions.

Experimental Setup. Experiments using N₂ are described here. The aqueous sample was either deionized (DI) water or NaCl brine with a salinity of 50,000 ppm. The stainless-steel porous membrane used had a porosity of 37%, an average pore size of 5 m (maximum 10 μm), an outer diameter of 25.4 mm, and a length of 3 mm. The stainless steel consisted of 16-18% Cr, 11-14% Ni, 2-3% Mo, <0.03% C, <2% others, and Fe (the rest).

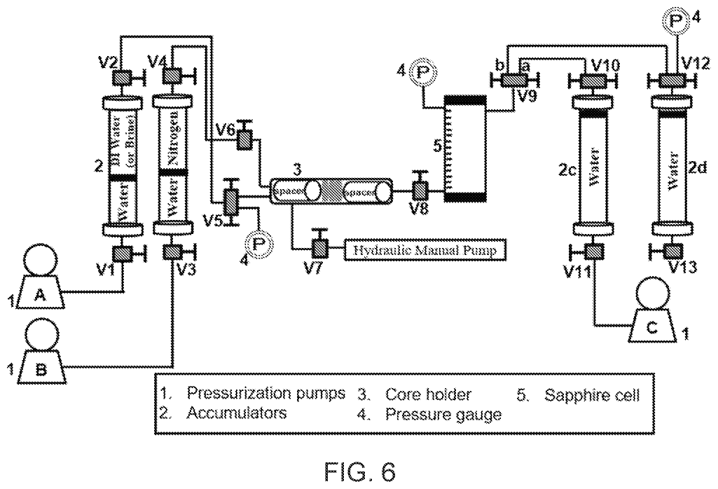

FIG. 6 shows a schematic of the experimental setup for the gas content measurement. The setup uses accumulators for DI water (or NaCl brine) and N₂, pressurization pumps to maintain the pressure of testing samples in the accumulators, a Hassler-type core holder to house the porous membranes, a hydraulic manual pump to maintain overburden pressure in the core holder, and a sapphire visualization cell. The sapphire cell is used for optimal observation of testing fluids and has an internal volume of 8 mL. It can withstand high pressures up to 700 bar and temperatures up to 423 K. Additional accumulators (receivers) are connected to the outlet of the sapphire cell to collect effluent samples. One of the receiver accumulators (2c) is placed to collect fluids from the sapphire cell during the co-injection period. The other receiver accumulator (2d) is placed to collect depressurized gas after the co-injection period.

Experimental Procedure. To prepare aqueous NB fluids, several variables—pressure, injection rates (volumetric co-injection ratio), salinity—were tested. The experimental pressure ranged from 500 psi to 4000 psi and the temperature was 294 K (room temperature). Two injection rates were used: rate 1 at 25 mL/h and rate 2 at 100 mL/h. The volumetric co-injection ratios were either ratio 1 (90% N₂ and 10% DI water or brine), or ratio 2 (50% N₂ and 50% DI water or brine). With rate 2 and ratio 2, for example, N₂ at 50 mL/h and DI water or brine at 50 mL/h are co-injected into the porous membrane, with both volumetric rates at the operating pressure and temperature. The salinity variable was tested using 50,000-ppm NaCl brine. For each pressure, injection rate, co-injection ratio, and salinity configuration, the procedure remained the same. The experimental procedure for an example configuration is described below.

The tubing lines, core holder, sapphire cell, and the top of the receiver accumulators were evacuated for 1 hour. The system was saturated with DI water or brine up to the top of receiver accumulator 2c while keeping valve V9b closed. N₂ and DI water or brine were co-injected at constant flowrate (rate 1 or 2) at a specified co-injection ratio (ratio 1 or 2) through the filters, and passing through the sapphire visualization cell, for a period of 2 hours to fill the cell with aqueous NB fluid. The receiver accumulator (2c) received the co-injected fluids at a constant refill flowrate (rate 1 or 2) to maintain the pressure in the system. After the co-injection period, the sapphire cell was isolated by closing valves V8 and V9a. The N₂ content in the aqueous NB fluid was determined by gradually depressurizing the system to atmospheric pressure. Valve V9b was first opened to fill the tubing line with depressurized N₂, followed by valve V12 to fill the dead volume of accumulator 2d, and then valve V13 to collect displaced fluids corresponding to the volume of the accumulator filled with depressurized N₂. The volume of the collected fluids, the volume of the tubing line, and the dead volume of accumulator 2d represent the volume of N₂ at atmospheric pressure under the assumption that there is no N₂ in the remaining water phase in the sapphire cell and no water in the expanded gas phase. The volume of N₂ in the aqueous NB fluid at experimental pressure was then calculated by using

$${[ PV / Z ]}_{exp} = {[ PV / Z ]}_{atm}$$

where P, V, and Z are pressure, volume, and compressibility factor. The subscript exp stands for the experimental conditions, and the subscript atm stands for the atmospheric pressure conditions. In the above equation, the right-hand side is a measured value, assuming Zₐₜₘ=1.0 (ideal gas). Dividing the value by the product of the universal gas constant and the experimental temperature gives the mole number of N₂. Then the gas content is represented in units of mole fraction as follows:

$$x ( {N}_{2} ) = \frac{n ( {N}_{2} )}{n ( {N}_{2} ) + n ( DI water ( or brine ) )}$$

where n is the number of moles of a substance.

The above procedure is corrected when the mass of the remaining water in the sapphire cell is measured. The mass divided by the water density at the temperature and pressure will be subtracted from the volume of the sapphire cell to obtain a more precise volume of N₂ in the sapphire cell after the depressurization.

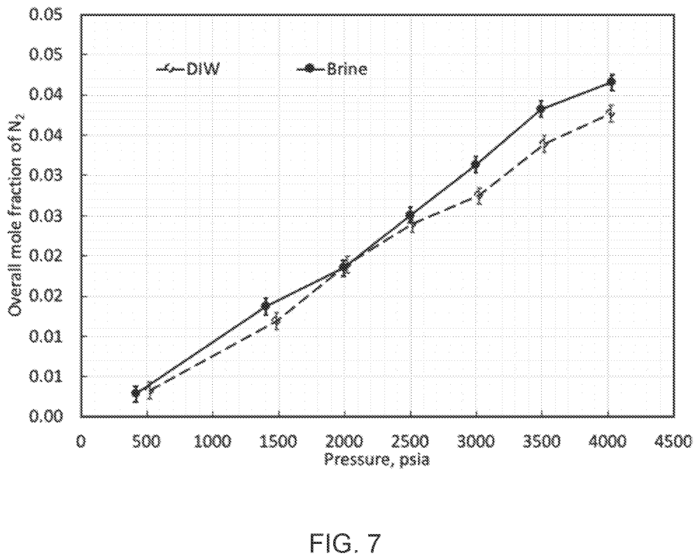

Results. The initial stage of the experiment has generated a preliminary set of data based on the assumption that there is no water in the expanded gas volume at atmospheric pressure as described above. FIG. 7 shows the mole fractions of N₂ in the aqueous NB fluids for the total injection rate of 100 mL/h with 50% N₂ and 50% water or brine at different pressures. For example, the mole fraction of N₂ obtained for the DI water case is 0.038 at 4023 psia and that for the brine case is 0.042 at 4031 psia. The thermodynamic solubility of N₂ in water at the same temperature and pressure is 0.002. That is, the N₂ content in the former is 19 times greater and that for the latter is 21 times greater than the thermodynamic solubility.

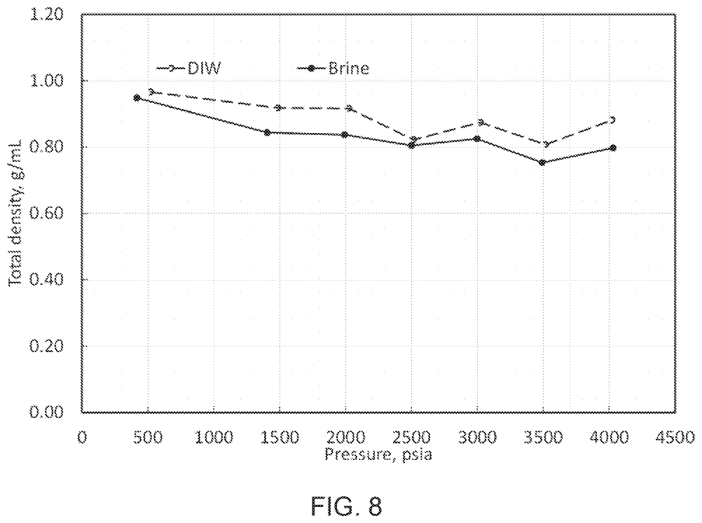

FIG. 8 shows the mass densities of the resulting NB fluids shown in FIG. 7. The mass density of the NB fluid prepared with DI water is 0.881 g/mL at 4023 psia and that with the brine is 0.798 g/mL at 4031 psia.

Apparent viscosity. The presence of gas bubbles in the aqueous NB fluid can be confirmed by the gas content measured by the depressurization. Application of the aqueous NB fluid for subsurface formations, such as geological CO₂ sequestration, requires the knowledge of apparent viscosity in porous media. Gas bubbles in the aqueous NB fluid are expected to increase the apparent viscosity analogous to other dispersed particles, such as oil-in-water emulsion.

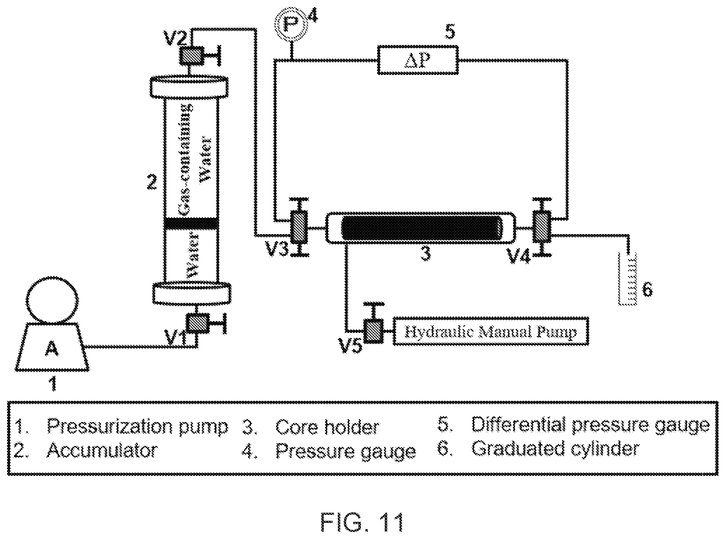

Therefore, the apparent viscosity of aqueous NB fluid was measured using a core flooding setup as shown in FIG. 11. The setup consists of a pressurization pump, an accumulator containing the aqueous NB fluid, a core holder housing a Berea sandstone core, pressure gauges, and a graduated cylinder to collect the effluent sample. The Berea sandstone core was of 9 inches in length and 1 inch in diameter.

First, a sample of the aqueous NB fluid was prepared and stored in an accumulator. The sample was prepared by co-injecting N₂ and DI water at a 50% N₂ and 50% DI water (or brine) co-injection ratio at 100 mL/h through stainless-steel porous membranes. The pressure was 1800 psi and the co-injection was at room temperature. Then, the system was evacuated for 1 hour. The sandstone core was saturated with DI water (or brine) to determine the porosity and permeability of the core. Then, the DI water (or brine) in the system was displaced with the aqueous NB fluid at a flowrate of 50 mL/h and the pressure drop across the core was determined. The apparent viscosity was calculated using Darcy's law.

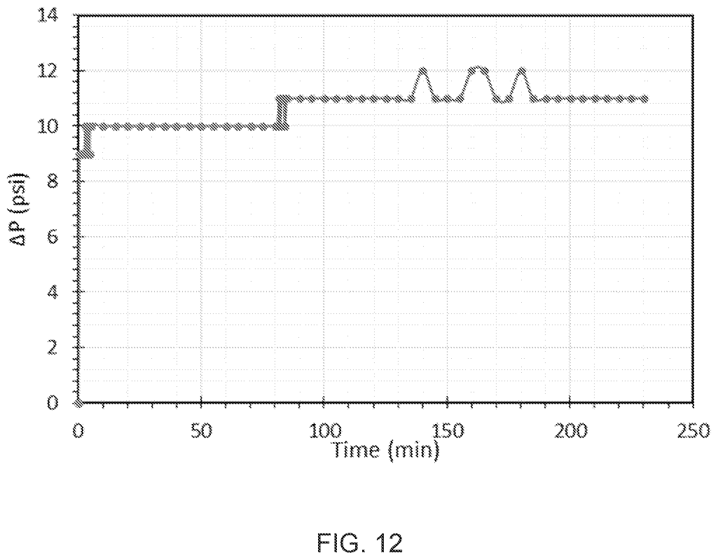

FIG. 12 shows differential pressures during the apparent viscosity measurement for the aqueous NB fluid with brine and N₂ using a Berea sandstone core as described above. In this figure, the red and blue points show the data during the brine injection stage, and the aqueous NB fluid injection stage, respectively. The differential pressure increased from 10 psi to 11 psi, indicating the increase in apparent viscosity by 10%. This indicates the presence of gas bubbles in the aqueous NB fluid tested.

The transport of N₂ as the aqueous NB fluid and that in the water-gas two-phase flow can be compared by using the mole fraction of N₂, the molar density, and the viscosity of the aqueous NB fluid along with measured water-gas relative permeabilities for Berea sandstone cores (Chen et al. 2016). Results show that the transport of N₂ in the aqueous NB Fluid is an order of magnitude smaller than that in the two-phase flow with the relative permeabilities. The main factor reducing the N₂ transport is the reduced mobility of the gas-bearing phase; that is, the aqueous NB fluid with a slightly increased apparently viscosity transports the N₂ much more slowly than the N₂ transport as the gas phase flowing concurrently with the water phase.

Figure Captions. FIG. 3A and FIG. 3B. Sample calculations of phase equilibrium for the N₂-water binary system at 297 K with a bubble radius of 10 nm using the Peng-Robinson equation of state. (FIG. 3A) Bulk pressure at 1.01 bar and (FIG. 3B) bulk pressure at 140 bar. At 1.01 bar, the water phase has two Gibbs free energy surfaces where the cubic EOS has two real roots.

FIG. 4. Interfacial tension between the external water phase and the gas bubbles for varying radius of the bubbles based on the in-house software. Except for the varying bubble radius, the conditions are the same as those for FIG. 3B.

FIG. 5. Calculation example in which the energy released by the phase split is equal to the energy required for the bubbles to create the interfacial area in the system. The vertical axis is the energy that can be released by forming two phases from a single phase, in the dimensionless Helmholtz free energy divided by molar volume (Helmholtz free energy density). The horizontal axis is the component molar density space (dimensionless) scaled between the equilibrium tie line.

FIG. 6. Schematic of the experimental setup for the gas content measurement.

FIG. 7. Results of the gas content measurements under the assumption that there is no water in the expanded gas phase upon the depressurization.

FIG. 8. Mass densities of the aqueous NB fluids shown in FIG. 7.

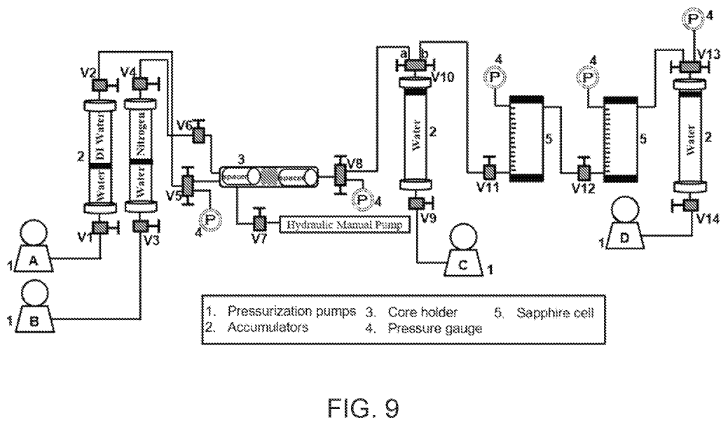

FIG. 9. Schematic of the stability test setup.

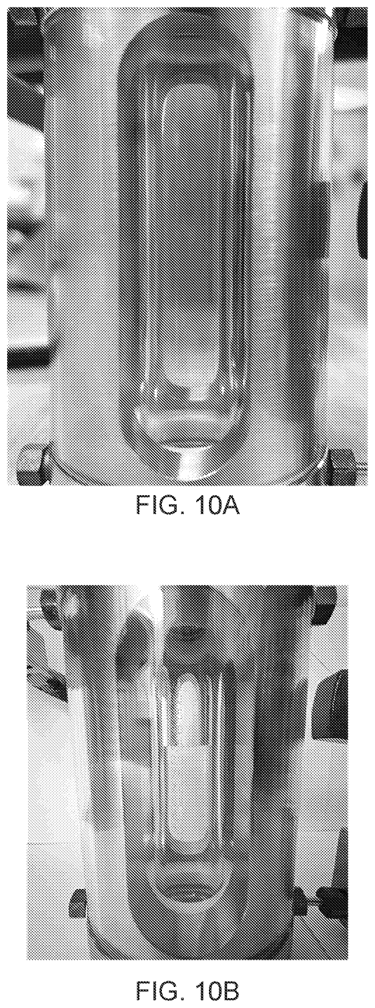

FIG. 10. Photos of the sapphire cells that contains the aqueous NB fluid at approximately 1800 psig at room temperature: (FIG. 10A) without N₂ gas cap, (FIG. 10B) with N₂ gas cap. The 2^{nd} sample appears to be white in the aqueous NB fluid because of the white background, but it is transparent just like the 1^{st} sample above.

FIG. 11. Schematic of the apparent viscosity measurement setup.

FIG. 12. Differential pressures during the apparent viscosity measurement for the aqueous NB fluid with brine and N₂ using a Berea sandstone core.

### Example 2: Thermodynamic Modeling of Aqueous Nanobubble Dispersion

The amount of gaseous species in water or brine can be greatly enhanced in the form of a nanobubble (NB) dispersion. Aqueous NB dispersions have vast industrial applications, potentially in enhanced oil recovery and carbon dioxide (CO₂) sequestration to control the mobility of gaseous species. A proper understanding of thermodynamic properties of aqueous NB dispersion may allow for further development of such NB technologies. An objective of this example is to analyze the thermodynamic stability of aqueous NB dispersion and to apply a thermodynamic equilibrium model to analyze experimental data.

This example presents a thermodynamic formulation for modeling aqueous NB dispersion, which clarifies that aqueous NB dispersion occurs in the aqueous phase that is supersaturated by the gaseous species in the system. That is, the gaseous species are present in two modes: dispersion of gas bubbles under capillary pressure, and molecule dispersion (supersaturation) in the external aqueous phase. Such a thermodynamic system is referred to as aqueous NB fluid in this Example, and specified by (NC+3) variables (e.g., temperature, total volume, components' mole numbers, and capillary pressure), in which NC is the number of components. This example then presents a novel implementation of the GERG-2008 equation of state (EOS) in minimization of the Helmholtz free energy to solve for equilibrium properties of aqueous NB fluid. GERG-2008 was used in this Example because it is suitable for modeling an aqueous phase that is supersaturated by gaseous species.

The thermodynamic equilibrium model was applied to experimental data of aqueous NB fluid with nitrogen (N₂) at pressures up to 277 bara (4019 psia) and 295.15 K (71.6° F.). Application of the model to experimental data indicates that a large fraction (0.8-0.9) of the total amount of N₂ is in the form of molecule dispersion, but such supersaturation of the aqueous phase is possible because of the presence of NB dispersion with capillary pressure. That is, NB dispersion can increase the gas content in aqueous NB fluid by enabling gas supersaturation in the aqueous phase as a thermodynamic system. Although experimental uncertainties resulted in a possible range of equilibrium properties for aqueous NB fluids at high pressures, the extrapolation of the calculation results to atmospheric pressure yielded a radius and a number density of bubbles within the range of data reported in the literature.

Many gaseous species, such as CO₂, H₂, N₂, and light hydrocarbons, are highly immiscible with water, and their equilibrium concentrations in aqueous fluid (water or brine) are often quite small under a wide range of conditions. However, various industrial processes can benefit if these immiscible gaseous species can be contained in the aqueous fluid as an effectively homogeneous phase, in which the external aqueous phase contains immiscible gas bubbles with a large number density.

There are many applications of gas bubbles in food, agriculture, wastewater treatment, mineral processing, pharmaceutical, and other industries. However, these applications are limited primarily to atmospheric pressure, in which the bubbled water is generated in an open system near atmospheric pressure. Such aqueous bubbles are not thermodynamically stable because the system is open, and are not kinetically stable at a large number density without continuous addition of energy.

This Example is concerned with development of the nanobubble technology that generates such aqueous fluids that can contain a large amount of an immiscible gas or gas mixture at elevated pressure in a controlled and scalable manner. The technology aims to make the gaseous species stably dispersed in the aqueous fluid as small bubbles, typically at a nano-meter scale, and as dissolved molecules. These two modes (bubble dispersion and molecule dispersion) of containment can collectively make the overall concentration of the gaseous species greater than its thermodynamic solubility in the aqueous fluid. Such aqueous fluid with gas-bubble/molecule dispersion is referred to as “aqueous NB fluid” in this Example.

As is shown in further detail below, aqueous NB fluid can be generated with a greater amount of the gaseous species at a higher pressure, and therefore, it finds more useful applications at elevated pressures. From the thermodynamic point of view, this is quite different from other technologies addressing the question of a single bubble or multiple bubbles in an open system at low pressure. However, no method until now had been found to control and design the physical and transport properties of such gas-containing fluids at high pressures, likely due to the lack of rigorous thermodynamic analysis and engineering tools for aqueous NB fluid.

High-pressure non-subsurface processes that can benefit from the NB technology include CO₂ electrochemical reaction processes and any other reactions that require a high concentration of gas species as reactants in aqueous reaction media. The technology can be used for high-pressure storage of gases, such as H₂, in tanks, pipes, and other pressure vessels. Some surface processes do not require long-term stability of NB since they use the gaseous species for reactions (consumption).

Subsurface applications of the NB technology include enhanced oil recovery (EOR) by gas injection and geological storage of gases in hydrocarbon reservoirs and aquifers. In gas EOR, the injected gas not only flows through high-permeability layers and/or fracture networks, but also gravity-segregates to the upper zones of the target reservoir. Such undesired flow regimes result in a rapid breakthrough of the injected gas to production wells, leading to inefficient volumetric sweep and costly recycling of the injection gas. To alleviate the problem, water-alternating-gas (WAG) injection is commonly employed; however, the water and gas may segregate, losing the effectiveness of WAG. A low concentration of specially formulated surfactants can be added to the water so that a surfactant-stabilized gas foam bank is generated. With the high apparent viscosity of foam phase, a better mobility control of the gas injection is expected. However, two main weaknesses of such gas foam technologies are (i) the stability of foam flowing in reservoir pores is difficult to control, and (ii) the use of surfactant adds to the complexity and cost of the field operations.

The NB technology can effectively reduce the mobility of the injected gas since it flows with the external aqueous phase as the carrier, with no risk of gas bubbles being trapped at rock pores. The apparent viscosity of the aqueous NB fluid is shown to be slightly greater than the external phase alone with no NB. Therefore, the mobility of the gaseous species contained in the aqueous NB fluid will be reduced substantially, by a factor of 10 in the experimental case with a Berea sandstone core, in comparison to two-phase slippage flow with relative permeabilities. The reduced mobility of gaseous species is beneficial both for EOR and gas storage applications.

The aqueous NB fluid that contains the gaseous species as bubbles at the nanoscale can flow like ordinary brine in geological formations. The NB dispersion can substantially suppress the buoyant forces in comparison to when the gas is injected as a bulk gas phase in the presence of water.

When the technology is applied for geological CO₂ sequestration, it can substantially enhance the kinetics of carbon mineralization for robust carbon sequestration. Along with the mineralization, the reduced buoyant forces due to the containment of CO₂ as NB in the brine can mitigate the potential leakage of CO₂ to the surface through any hydraulic paths (faults and old wells). Many biogenic gas reservoirs can be used for CO₂ sequestration, but contamination of the reservoir gas by the injected CO₂ is a major concern. Using the nanobubble technology, the mixing of CO₂ and natural gas (mainly methane) can be controlled by containing the CO₂ in the injected aqueous phase.

A theoretical understanding of aqueous NB fluid is useful in developing nanobubble technologies. Software has been developed to perform thermodynamic calculations of fluid phases with curved interfaces, including gas bubbles in aqueous fluid. This Example presents the thermodynamic equilibrium model that enables a fundamental understanding of various factors affecting the properties of aqueous NB fluid. In this Example, aqueous NB fluid is modeled as a thermodynamically stable state of a closed system, in which the external aqueous phase and the bubble phase coexist with no bulk gas phase for water and gaseous species.

Thermodynamic formulation of phase stability analysis has been established after Gibbs' original work, but there had been no rigorous solution to the phase stability problem in the presence of capillary pressure. Therefore, fundamental changes to the theoretical formulation were made by using the Helmholtz free energy, instead of the Gibbs free energy, for phase stability and equilibrium calculations under capillary pressure. In addition, however, modeling the properties of aqueous NB fluid makes use of an equation of state (EOS) that is capable of modeling water, a polar species. Also, the external aqueous phase is supersaturated by gaseous species in aqueous NB fluid; hence, the EOS used for this Example must be reliable in metastable conditions.

Although cubic EOSs have been traditionally used for predominantly hydrocarbon mixtures, they are not suitable for modeling strong intermolecular interactions owing to polarity, such as hydrogen bonding and dipole interactions in liquid phases. The GERG-2004 EOS was developed for the accurate prediction of thermodynamic properties of fluids. The EOS was calibrated for 18 species commonly present in natural gas, such as alkanes, water, and CO₂. The accuracy of the GERG-2004 EOS relied on a large fluid database from 650 experimental data sources, covering different types of thermodynamic properties, such as PVT data, vapor-liquid equilibrium data, saturated liquid densities, and enthalpy changes. Then, the GERG-2008 EOS extended the GERG-2004 model to 21 species. The new model also extended the applicable conditions from 450 K to 700 K, and from 35 MPa to 70 MPa, covering the vapor, liquid, supercritical, and multiphase regions. The GERG-2008 EOS has been shown to be superior to cubic EOSs in terms of liquid density predictions over a wide range of temperature and pressure conditions.

The formulation of GERG-2008 takes an explicit form of reduced Helmholtz free energy as a function of reduced temperature, reduced density, and composition, which facilitates the thermodynamic computations based on minimization of the Helmholtz free energy. Also, the GERG-2008 EOS has been compared with other EOSs for the ability to reproduce spinodal limits and metastable zones for pure components. GERG-2008 was found to be more accurate than other Helmholtz-based EOSs, such as SAFT EOS. In this Example, therefore, the GERG-2008 EOS is adopted for the phase equilibrium calculation for aqueous NB fluids.

There are a few challenges in applying the GERG-2008 EOS for modeling aqueous NB Fluids. For example, GERG-2008 is not quite accurate for phase-boundary predictions for CO₂-containing mixtures and gas solubility in water. As will be shown in this Example, the residual part of the reduced Helmholtz free energy consists of two parts, a linear combination of residual parts for each component in the mixture, and a departure function, in GERG-2008. The departure function was only calibrated for 7 hydrocarbon binaries. The matching for water/CO₂ mixtures was improved by calibrating the departure-related coefficients. This example revisits the modifications in terms of departure functions and further improves the accuracy of GERG-2008 for water/N₂ mixtures.

Also, the determination of the right compressibility factor is more challenging with GERG-2008 than with cubic EOSs. GERG-2008 can have more than three roots and no analytical solution exists for the root-finding problem. Commercial codes, such as REFPROP, may cause convergence issues because of an erroneous compressibility factor. A more robust algorithm for compressibility factor with GERG-2008 is developed here.

This Example first presents the formulation and algorithms for computing the properties of aqueous NB fluids using the GERG-2008 EOS. The model is then used to match and analyze the experimental data of aqueous NB fluid with N₂. It is believed that this is the first time aqueous NB fluids are modeled using rigorous thermodynamic principles with a quantitatively reliable EOS, GERG-2008.

Formulation. The formulation and algorithms for computing the equilibrium properties of aqueous NB fluid are presented here. The thermodynamic model can estimate properties of aqueous NB fluid at given thermodynamic conditions (e.g., component mole numbers, temperature, volume, and bubble radius), assuming a uniform size of bubbles.

Thermodynamic stability and equilibrium of aqueous nanobubble fluid. Phase equilibrium with capillary pressure is most naturally modeled by minimization of the Helmholtz free energy. The iterative solution to a phase equilibrium problem using an EOS is quite non-linear, but using the Helmholtz free energy involves only one energy surface, unlike the conventional method of using the Gibbs free energy, regardless of the number of phases with capillary pressure. Pressures for different equilibrium phases (i.e., capillary pressure) were inherently modeled as part of the minimization of the Helmholtz free energy. A brief review of the formulation and also gives equilibrium properties of aqueous NB fluids are provided.

A closed system at a fixed temperature T, total volume Vₜₒₜₐₗ, and total mole numbers nᵢ (i=1, 2, . . . , N_{C}) of N_{C} components is at an equilibrium state when the Helmholtz free energy of the system cannot be reduced for any possible perturbation. That is, the system is stable if

$${dA}_{total} = dAv + {dA}_{σ} , + {dA}_{L} \geq 0 \qquad ( 1 )$$

for any perturbation of thermodynamic variables. In the above equation, dAₜₒₜₐₗ, dA_{V}, dA_{σ}, and dA_{L} respectively represent the change in the Helmholtz free energy for the system, the vapor phase, the interface, and the liquid phase. The changes in the Helmholtz free energy for the V and L phases are

$${dA}_{V} = - {S}_{V} {dT}_{V} - {P}_{V} {dV}_{V} + {\sum }_{i = 1}^{{N}_{c}} {\overline{G}}_{i V} d {n}_{i V} \qquad ( 2 )$$

$${dA}_{L} = - {S}_{L} {dT}_{L} - {P}_{L} {dV}_{L} + {\sum }_{i = 1}^{{N}_{c}} {\overline{G}}_{i L} d {n}_{i L} \qquad ( 3 )$$

and the change in the Helmholtz free energy for the interface is

$${dA}_{σ} = - {S}_{σ} {dT}_{σ} - {P}_{σ} {dV}_{σ} + {\sum }_{i = 1}^{{N}_{C}} {\overline{G}}_{i σ} {dN}_{i σ} + σ da . \qquad ( 4 )$$

In the above equations, S is entropy, T is temperature, P is pressure, V is volume, and G̅ᵢ is the partial molar Gibbs free energy of component i, σ is the interfacial tension (IFT) between the V and L phases, a is the interfacial area, nᵢ is the mole number of component i, and N_{C} is the number of components.

The thermodynamic specifications of T, Vₜₒₜₐₗ, and nᵢ require

$${dn}_{i V} + {dN}_{i σ} + {dN}_{i L} = 0 \qquad ( 5 )$$

$${dV}_{V} + {dV}_{σ} + {dV}_{L} = 0 \qquad ( 6 )$$

$${dT}_{V} = {dT}_{σ} = {dT}_{L} = 0. \qquad ( 7 )$$

These conditions yield

$${dA}_{tota1} = - ( {P}_{V} - {P}_{L} ) {dV}_{V} - ( {P}_{σ} - {P}_{L} ) {dV}_{σ} + {\sum }_{i = 1}^{{N}_{c}} ( {\overline{G}}_{i V} - {\overline{G}}_{i L} ) d {n}_{i V} + {\sum }_{i = 1}^{{N}_{c}} ( {\overline{G}}_{i σ} - {\overline{G}}_{i L} ) {dn}_{i σ} + σ da . \qquad ( 8 )$$

Since dV_{σ} and dn_{iσ} are relatively small, the second and fourth terms are negligible in comparison to the other terms on the right-hand side of the above equation. Then,

$${dA}_{total} = - ( {P}_{V} - {P}_{L} ) {dV}_{V} + {\sum }_{i = 1}^{{N}_{c}} ( {\overline{G}}_{i V} - {\overline{G}}_{i L} ) {dn}_{i V} + σ da . \qquad ( 9 )$$

dAₜₒₜₐₗ tends to zero with diminishing net mass transfer between the V and L phases; that is,

$${\overline{G}}_{i V} - {\overline{G}}_{i L} = 0 . \qquad ( 10 )$$

dAₜₒₜₐₗ=0 and equation 10 require the following condition:

$$( {P}_{V} - {P}_{L} ) {dV}_{V} = σ da , or {P}_{V} - {P}_{L} = σ da / {dV}_{V} . \qquad ( 11 )$$

Then, equations 10 and 11 define the first-order necessary conditions for the Helmholtz free energy to be a minimum at a given T, Vₜₒₜₐₗ, and nᵢ (i=1, 2, . . . , N_{C}). Note that Equation 11 holds for equilibrium phases.

The minimization of the Helmholtz free energy is subject to the molar volume constraint

$${V}_{j} > {V}_{limj} \qquad ( 12 )$$

where for the L and V phases (j=V or L) and the positivity of mole numbers

$${n}_{ij} > 0 \qquad ( 13 )$$

where i=1, 2, . . . , N_{C} and j=V or L. In equation 12, Vₗᵢₘⱼ represents the smallest possible molar volume by the EOS used. For cubic EOSs [e.g., the Peng-Robinson EOS], Vₗᵢₘⱼ is the co-volume parameter.

Equation 9 or 11 clarifies that interfacial area, a, gives a state variable, P_{V}-P_{L}, for thermodynamic aqueous NB fluid, which is constant at zero for the phase equilibrium state with a planar interface between fluid phases. Assuming a uniform radius, r, of N_{b} bubbles for V_{V} at equilibrium,

$${V}_{V} = 4 π {r}^{3} {N}_{b} / 3 \qquad ( 14 )$$

and the total surface area, a, is

$$a = 4 π {r}^{2} {N}_{b} . \qquad ( 15 )$$

Using Equations 14 and 15, the capillary pressure P_{C}(=P_{V}−P_{L}) is

$${P}_{C} = σ da / {dV}_{V} = 2 σ / r . \qquad ( 16 )$$

Note that in equation 16, P_{C} depends on r assuming the V phase is a number of spherical bubbles with a uniform radius r. Therefore, it is possible to specify a value for P_{C} by specifying r and a value or function for σ in addition to T, Vₜₒₜₐₗ, and nᵢ (i=1, 2, . . . , N_{C}). For a given equilibrium solution, the number of bubbles, N_{b}, can be calculated by using equation 14.

The problem of thermodynamic aqueous NB fluid given above is quantitatively solved by using the GERG-2008 EOS in this Example. The existence of a thermodynamically valid solution using such a quantitatively accurate EOS indicates the feasibility or stability of individual NB in the aqueous phase that is supersaturated by the gaseous species. Finding such a valid solution is in contradiction to the process called the Laplace Pressure Bubble Catastrophe, which has been discussed qualitatively without even specifying the system of interest in the NB-related literature. Note that the multibody stability of NB cannot be analyzed in the above thermodynamic framework, and perhaps detailed experiments are important at the current stage of research.

Bubble nucleation. When aqueous NB fluid is formed from a mixture of water and gaseous species using a certain device, a sufficient amount of energy must be available to cause the interfacial area for the bubbles in the external water phase in the system at equilibrium. When such a system is set at a given temperature and total volume, the total Helmholtz free energy of the mixture is reduced to that of aqueous NB fluid consisting of two phases (the external water phase and gas bubbles). This reduction in the Helmholtz free energy ΔAₜₒₜₐₗ must be greater than the total Helmholtz free energy for the interface. This is a theoretical thought process without specifying the process of generating such aqueous NB fluid; therefore, the nucleation criterion given in this section is less strict than the requirement in actual processes. For example, any dissipation will demand an additional amount of energy beyond the theoretically required amount of energy.

The Helmholtz free energy for the original mixture is A_{I} and that for aqueous NB fluid is (A_{V}+A_{σ}+A_{L}). For the latter state to be thermodynamically more stable than the former, A_{I}>(A_{V}+A_{σ}+A_{L}) or

$${A}_{I} - ( {A}_{V} + {A}_{L} ) > {A}_{σ} = σ a \qquad ( 17 )$$

assuming the mole numbers of components and the volume for the interface are small so that A_{σ}=G_{σ}−P_{σ}V_{σ}+σa can be approximated to be A_{σ}=σa. The total volume of the system Vₜₒₜₐₗ is common for the initial and the final (equilibrium) states. Dividing equation 17 by VₜₒₜₐₗRT gives

$${A}_{RI} - ( {A}_{RV} {S}_{V} + {A}_{RL} {S}_{L} ) > ε , \qquad ( 18 )$$

where A_{RI}=A_{I}/VₜₒₜₐₗRT, A_{RV}=A_{V}/V_{V}RT, A_{RL}=A_{L}/V_{L}RT, S_{V}=V_{V}/Vₜₒₜₐₗ, S_{L}=V_{L}/Vₜₒₜₐₗ, and ε=σa/VₜₒₜₐₗRT. A_{RI} is the reduced Helmholtz free energy density at the initial state (hypothetically single phase), A_{Rj} is the reduced Helmholtz free energy density for phase j, Sⱼ is the equilibrium volumetric fraction (i.e., saturation) for phase j, and R is the universal gas constant.

The material balance for component i

$${n}_{i} = {n}_{iV} + {n}_{iL} \qquad ( 19 )$$

$$can be expressed as$$

$${d}_{i} = s {d}_{iV} + ( 1 - s ) {d}_{iL} \qquad ( 20 )$$

where dᵢ=nᵢ/Vₜₒₜₐₗ, d_{iV}=nᵢv/V_{V}, d_{iL}=n_{iL}/V_{L}. We use s in place of S_{V} for analyzing the nucleation criterion (equation 18) in s space. That is, if

$$D ( s ) = {A}_{RI} ( s ) - [ s {A}_{RV} + ( 1 - s ) {A}_{RL} ] > ε , \qquad ( 21 )$$

then aqueous NB fluid has a smaller Helmholtz free energy than the hypothetically single phase for the specified temperature, total volume, and mole numbers of components.

The D function is non-linear with s, while ε increases linearly with s with a slope of 3σ/rRT because ε=3σs/rRT. Note that at s=0, D=ε=0. Therefore, D>ε for a small value of s if the gradient of D with respect to s is greater than 3σ/rRT. The gradient of D is

$$\frac{\partial D}{\partial s} = {\sum }_{i = 1}^{{N}_{c}} ( ln {f}_{i} ( s ) - ln {f}_{i} ( s = 0 ) ) ( {d}_{iV} - {d}_{iL} ) + \frac{{p}_{V} - {P}_{L}}{RT} \qquad ( 22 )$$

where the Gibbs-Duhem equation was used. At s=0, the gradient becomes (P_{V}−P_{L})/RT. Then, the nucleation of bubbles for a small value of s is likely stable if

$${P}_{V} - {P}_{L} - 3 σ / r > 0. \qquad ( 23 )$$

Equation 23 cannot be met if P_{V}−P_{L}=2σ/r (see equation 16) as in the current thermodynamic analysis. Note that Equation 23 is similar to the widely used expression for the nucleation energy barrier. The criterion, equation 23, may be temporarily satisfied upon gas nucleation, but such bubbles may not be thermodynamically stable unless the more fundamental criterion, equation 21, is satisfied at equilibrium. This analysis indicates that the thermodynamic stability of aqueous NB fluid requires a minimum amount of gaseous species in the system so that the criterion shown by Equation 21 can be met.

Thermodynamic models. Equation of state. One challenge in accurately modeling multiphase behavior including capillary pressure is that the equilibrium phase of lower pressure lies on the metastable part of the free energy surface. This part of the free energy lies outside the traditional range of thermodynamic variables used for calibrating the EOS. As a result, most EOS are uncertain in the accuracy of modeling metastable phases. The GERG-2008 EOS is relatively accurate in modeling metastable phases.

The GERG-2008 EOS is a multiparametric EOS and gives the value of the Helmholtz free energy as a function of composition, temperature, and molar density. This section presents the equations for the Helmholtz free energy as given by the GERG-2008 EOS. The analytical expression for other thermodynamic variables, such as pressure and fugacity, have been described. The EOS in a dimensionless form is

$$α ( δ , τ , x ) = \frac{\underline{A}}{R T} = {α}^{0} ( \underline{d} , T , x ) + {α}^{r} ( δ , τ , x ) , \qquad ( 24 )$$

where δ is the reduced density,

$$δ = \underline{d} / {\underline{d}}_{r} ( x ) , \qquad ( 25 )$$

τ is the inverse of reduced temperature,

$$τ = {T}_{r} ( x ) / T , \qquad ( 26 )$$

α⁰ represents the contribution from the ideal gas mixture using d, T, and x, and α^{r} represents the residual mixing behavior using δ, τ, and x. In equations 24 and 25, dᵣ and Tᵣ are the reducing molar density and temperature defined as

$$\frac{1}{{\underline{d}}_{r}} = {\sum }_{i = 1}^{{N}_{c}} \frac{{x}_{i}^{2}}{{\underline{d}}_{c i}} + \frac{1}{4} {\sum }_{i = 1}^{{N}_{c} - 1} {\sum }_{j = i + 1}^{{N}_{c}} {x}_{i} {x}_{j} {β}_{{vij}^{{Y}_{vij}}} \frac{{x}_{i} + {x}_{j}}{{β}_{vij}^{2} {x}_{i} + {x}_{j}} {( \frac{1}{{\underline{d}}_{ci}^{\frac{1}{3}}} + \frac{1}{{\underline{d}}_{cj}^{\frac{1}{3}}} )}^{3} \qquad ( 27 )$$

$$and$$

$${T}_{r} = {\sum }_{i = 1}^{{N}_{c}} {x}_{i}^{2} {T}_{c i} + {\sum }_{i = 1}^{{N}_{c} - 1} {\sum }_{j = i + 1}^{{N}_{c}} 2 {x}_{i} {x}_{j} {β}_{Tij} {γ}_{Tij} \frac{{x}_{i} + {x}_{j}}{{β}_{Tij}^{2} {x}_{i} + {x}_{j}} \sqrt{{T}_{c i} {T}_{cj}} \qquad ( 28 )$$

where βᵥᵢⱼ, γᵥᵢⱼ, β_{Tij}, and γ_{Tij} are calibration parameters that can be adjusted to match experimental data. The code for the GERG-2008 EOS was developed by converting FORTRAN77 code to a modern FORTRAN (FORTRAN2003) and by adding the missing routines for derivatives of pressure with mole number, logarithm of fugacity, and derivatives of the logarithm of fugacity.

Calibrated parameters βᵥᵢⱼ, γᵥᵢⱼ, β_{Tij}, and γ_{Tij} for the reduced temperature, molar density, and residual component for the Helmholtz free energy of water/gas systems are available. However, this calibration did not use enough data to accurately calibrate the binary departure parameters for mixtures of water and gases, such as nitrogen (N₂) and carbon dioxide (CO₂). Another calibration of the binary departure EOS for mixtures of water with various gases included N₂ and CO₂.

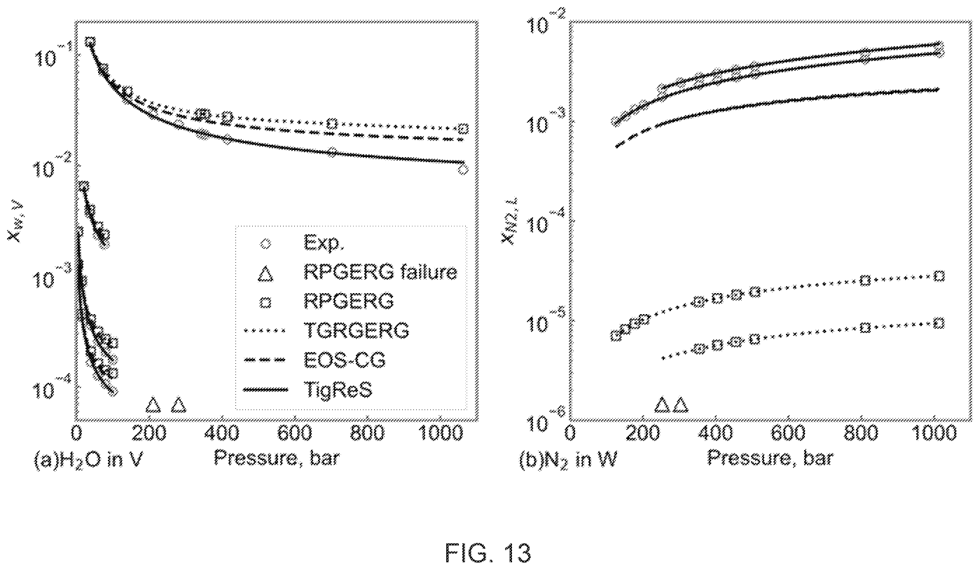

FIG. 13 shows experimentally measured and calculated values using different calibrations of the GERG-2008 EOS for the equilibrium water/N₂ mole fractions in the liquid and vapor phases at different temperatures and pressures. FIG. 13, panel a (left side) shows the mole fraction of water in the vapor phase and FIG. 13, panel b (right side) shows the mole fraction of N₂ in the liquid phase.

The REFPROP software developed by the National Institute for Science and Technology computes thermodynamic properties using various EOS. It includes liquid-vapor flash calculations using the GERG-2008 EOS. The hollow squares in FIG. 13 are the results using REFPROP. The dotted lines show the equilibrium mole fractions computed by the present implementation of the GERG-2008 EOS, which match the REFPROP values. The hollow triangles show the pressure values at which the flash calculation of REFPROP failed. The GERG-2008 EOS as implemented in this Example converged to the correct solution at all pressures. This demonstrates the improved robustness of the flash calculation algorithm used in this Example.

The dashed lines represent the equilibrium mole fractions computed by the EOS-CG calibration of GERG parameters. For water/N₂, neither GERG nor EOS-CG matches the data well. Therefore, the GERG parameters are recalibrated to match the data. Recalibrated GERG parameters are shown in Tables 1 and 2.

TABLE 1
Binary parameters for reducing parameter
functions for density and temperature.

| | β_{v, ij} | β_{T, ij} | γ_{v, ij} | γ_{T, ij} |
|---|---|---|---|---|
| N₂/H₂O | 1.058714 | 1.130886 | 0.9284938 | 0.8703639 |

TABLE 2
Coefficients and exponents for binary departure functions
αᵢⱼ^{r}. The N₂/H₂O are calibrated by minimizing the residuals
using Scipy's implementation of the Nelder-Mead algorithm.

| Binary pair | k | d_{ij, k} | t_{ij, k} | n_{ij, k} | Fᵢⱼ |
|---|---|---|---|---|---|
| N₂/H₂O | 1 | 1 | 1.0 | 1.872926 | 1.0 |
| | 2 | 1 | 1.55 | −1.830299 | |

One disadvantage of the multi-parametric GERG-2008 EOS is that it does not explicitly give an expression for the covolume parameter, which is used in some algorithms to compute the physical limits of the molar volume as constrained by Equation 12. Models were developed for pseudo-covolume parameters to match the molar volume that yields a pressure prediction of 2×10⁷ bar; i.e., b=V(P=2×10⁷ bar).

First, the pseudo-covolume values for pure N₂ and water were determined based on the GERG-2008 EOS as calibrated elsewhere as given in Table 3.

TABLE 3
Pseudo co-volume for pure substances based on GERG-2008.

| | N₂ | H₂O |
|---|---|---|
| b, cc/mol | 5.41358 | 4.83885 |

Two models were calibrated to covolumes of water/N₂ mixtures. The first model uses a geometrical average like the van der Waals mixing rule for the attraction parameter

$$b ( x ) = {\sum }_{i = 1}^{{N}_{c}} {\sum }_{j = 1}^{{N}_{c}} \sqrt{{b}_{i} {b}_{j}} {x}_{i} {x}_{j} ( 1 - {k}_{ij} ) , \qquad ( 29 )$$

where kᵢⱼ is a binary interaction parameter for the binary pair of components i and j. The second model uses the mixing rule for the reducing density mixing rule from the GERG-2008 EOS

$$b ( x ) = {\sum }_{i = 1}^{{N}_{c}} {x}_{i}^{2} {b}_{i} + {\sum }_{i = 1}^{{N}_{c} - 1} {\sum }_{j = i + 1}^{{N}_{c}} {c}_{b , ij} {f}_{b , ij} \\ where \qquad ( 30 )$$

$${c}_{b , ij} = 2 {β}_{b , ij} {γ}_{b , ij} {b}_{ij} , \qquad ( 31 )$$

$${f}_{b , ij} = {x}_{i} {x}_{j} \frac{{x}_{i} + {x}_{j}}{{β}_{b , ij}^{2} {x}_{i} + {x}_{j}} , \qquad ( 32 )$$

$${b}_{ij} = \frac{1}{8} {( {b}_{i}^{\frac{1}{3}} + {b}_{j}^{\frac{1}{3}} )}^{3} . \qquad ( 33 )$$

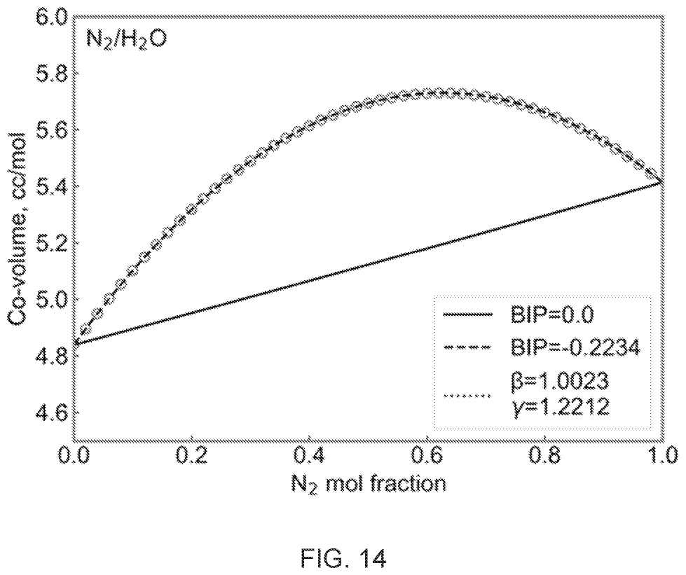

β_{b,ij} and γ_{b,ij} are calibrating parameters. FIG. 14 compares the pseudo-covolume parameter values calculated by the definitions above. Tables 4-7 show the pure substance covolumes and the calibrated parameters for both models.

TABLE 4
Co-volume for pure substances.

| | N₂ | H₂O |
|---|---|---|
| b, cc/mol | 5.41358 | 4.83885 |

TABLE 5
Optimal BIP values kᵢⱼ for the geometrical average.

| | N₂ | H₂O |
|---|---|---|
| N₂ | 0 | −0.2234 |
| H₂O | −0.2234 | 0 |

TABLE 6
Co-volume parameter β_{b, ij} for the GERG-type mixing rule.

| | N₂ | H₂O |
|---|---|---|
| N₂ | 0 | 1.0023 |
| H₂O | 1.0023 | 0 |

TABLE 7
Co-volume parameter γ_{b, ij} for the GERG-type mixing rule.

| | N₂ | H₂O |
|---|---|---|
| N₂ | 0 | 1.2212 |
| H₂O | 1.2212 | 0 |

Interfacial tension (IFT) for water and N₂. Equation 11 is one of the main equations solved by the phase-split calculation algorithm for the equilibrium properties of aqueous NB fluid in this Example. This equation is given by the pressure modeled by an EOS, and the capillary pressure for a given r. The equilibrium IFT is generally a function of the equilibrium phase compositions, L and V, where the L phase is in a metastable region of the free energy hypersurface. This subsection presents the development of an IFT model for water/N₂ nanobubbles that accounts for the L-phase compositions and density in the metastable region.

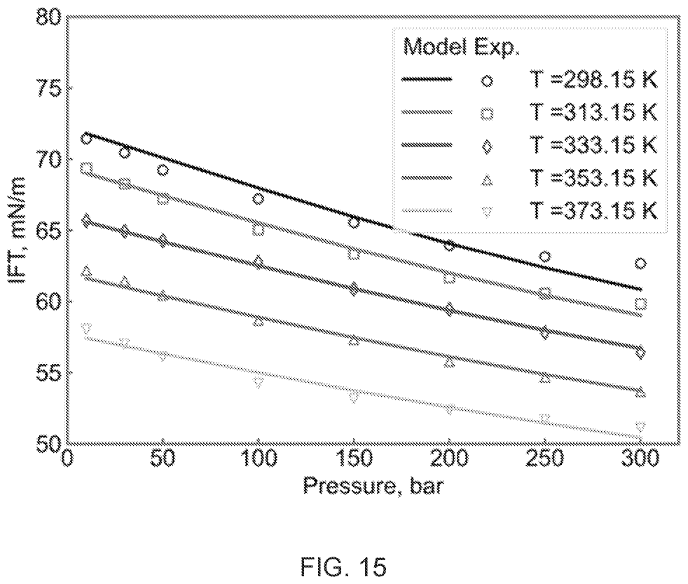

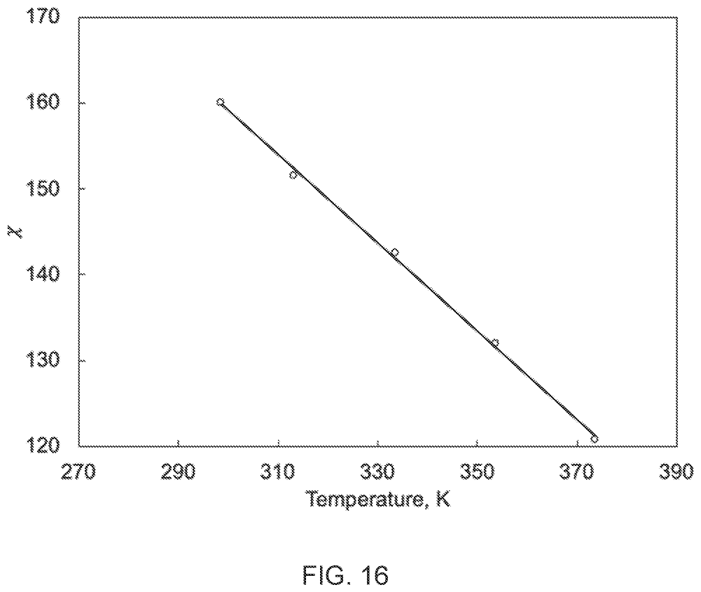

The IFT was calibrated based on data for a modified Parachor model

$$σ = {( χ {\sum }_{i = 1}^{{N}_{c}} {\prod }_{i} ( {\underline{d}}_{i L} - {\underline{d}}_{i V} ) )}^{γ} \qquad ( 34 )$$

where χ is a temperature-dependent coefficient. This modification can be implemented by simply changing the values of Πᵢ in the input file to χΠᵢ. The calculated IFT and experimentally measured values are shown in FIG. 15 using solid lines and hollow symbols at various temperatures and pressures. Table 8 shows the Parachor coefficients and calibrated Parachor exponent. FIG. 16 shows the χ parameter values for different temperatures, which can be linearly correlated as

$$χ = - 0.5191 ( T - 273.15 ) + 173.2 . \qquad ( 35 )$$

TABLE 8
Parachor coefficients for water and N₂ and Parachor exponent.

| | |
|---|---|
| γ | 0.7 |
| Π_{N}_{₂} | 61.12 |
| Π_{H}_{₂}_{O} | 51.0 |

Algorithms. This section presents a concise description of the flash calculation algorithm for a given composition and total molar volume, and two important developments that were necessary to implement the GERG-2008 EOS in minimization of the Helmholtz free energy. These models and algorithms include a correlation for pseudo-covolume parameter for gas-water mixtures and a new procedure for estimating the initial guess for the stability analysis and phase-split calculations.

Flash calculation. The algorithm uses the successive substitution (SS) method, followed by a Newton-Raphson (NR) algorithm. SS is based on Mikyška and Firoozabadi's (2011) adaptation of Michelsen's (1982) algorithm for minimization of the Helmholtz free energy. The switch from SS to NR occurs when the criterion

$${max}_{i < {N}_{c} + 1} \{ \vert {F}_{i} \vert \} < {ε}_{NR}$$

is met, where Fi for i=1, . . . N_{C} is

$${F}_{i} = ln {f}_{i V} - ln {f}_{i L} = 0 \qquad ( 36 )$$

and the capillary pressure equation

$${F}_{{N}_{c} + 1} = {P}_{V} - {P}_{L} - {P}_{cap} = 0. \qquad ( 37 )$$

The NR algorithm uses the number of moles and total volume of the vapor phase as the independent variables.

Each SS iteration contains two main steps: the composition update and the volume update. The composition update is based on the traditional method of Rachford and Rice that solves the material balance for ln Kᵢ

$$ln {K}_{i} = ln {x}_{i V} - ln {x}_{i L} . \qquad ( 38 )$$

The Rachford-Rice routine is used in this Example. The volumes are updated through the solution of the pressure equation, subject to the volume balance.

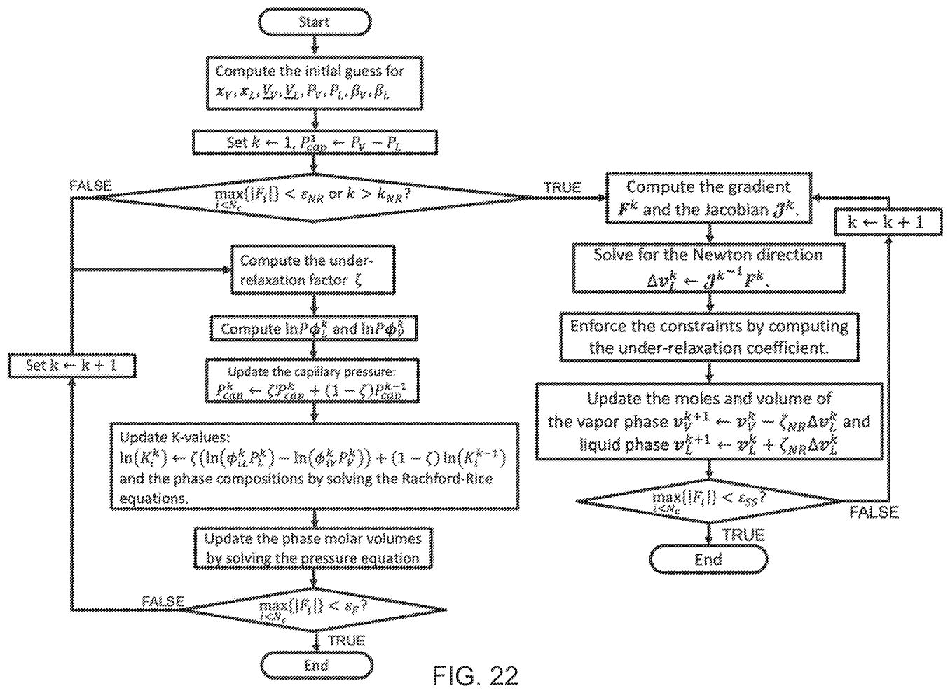

A concise description of the sequential iteration scheme for the SS algorithm is presented below, and a flowchart of the algorithm is shown in FIG. 22.

Step 1. Initialize ln K and V. Use the stability analysis if the reference phase is intrinsically stable; otherwise, use Wilson's correlation at the specified total molar volume. Initialize the iteration index k: k←1.

Step 2. If

$${max}_{i < {N}_{c}} \{ \vert {F}_{i} \vert \} > {ε}_{NR} ,$$

switch to the Newton-Raphson algorithm.

Step 3. Compute lnP

$${φ}_{L}^{k} , ln P {φ}_{V}^{k} ,$$

and the SS under-relaxation factor

$${ζ}_{SS}^{k} .$$

Step 4. Update the capillary pressure using the under-relaxation based on the capillary pressure model

$${P}_{C}^{k}$$

evaluated at composition

$${x}_{L}^{k - 1} and {x}_{V}^{k - 1}$$

and molar volumes

$${\underline{V}}_{L}^{k - 1} and {\underline{V}}_{V}^{k - 1} .$$

$${P}_{C}^{k} ← ( 1 - {ζ}_{SS} ) {P}_{C}^{k - 1} + {ζ}_{SS} {𝒫}_{C}^{k} .$$

Step 5. Update the phase compositions.

### Update lnK by Using a SS Step

In Kᵢ^{k}←(1−ζ_{SS})ln Kᵢ^{k-1}+ζ_{SS}(ln φ_{iL}P_{L}−lnφ_{iV}P_{V}), where i=1, . . . ,N_{c}.

Solve the Rachford-Rice equations for the phase compositions

$${x}_{L}^{k} and {x}_{V}^{k} ,$$

and the phase molar fractions

$${β}_{L}^{k} and {β}_{V}^{k} .$$

Step 6. Update the phase molar volumes by solving equation 13 using Newton's method.

Step 7. If the lower-pressure phase is intrinsically unstable, then use bisection to reduce its molar volume until it lies on the limit of intrinsic stability (spinodal boundary).

Step 8. Check for convergence. If

$${max}_{i < {N}_{c}} \{ \vert {F}_{i} \vert \} < {ε}_{F} ,$$

then stop. Otherwise, k←k+1 and return to step 2. In this Example, ε_{F} is set to 10⁻¹⁰.

In Step 2, the switching criterion from SS to NR

$${max}_{i < {N}_{c}} \{ \vert {F}_{i} \vert \} > {ε}_{NR}$$

is evaluated. The SS algorithm can be carried out until convergence without switching to the NR method by setting ε_{NR} to a value lower than that of ε_{NR}. A description of the sequential iteration scheme is presented below for when the switching criterion is satisfied, and the NR algorithm is activated. Specific expressions are used for computing the Jacobian [symbol] ^{k} for both the definite and indefinite solution.

Step 3. Compute the gradient F^{k} and the Jacobian [symbol] ^{k}.

Step 4. Solve for the Newton direction

$$Δ {v}_{L}^{k}$$

from equation

$${𝒥}^{k} ( Δ {v}_{L}^{k} ) = {F}^{k} .$$

Step 5. Compute the under-relaxation factor ζ_{NR} necessary to enforce the feasibility constraint equations 14 and 15.

Step 6. Update the number of moles and volume of the vapor phase

$${v}_{V}^{k + 1} ← {v}_{V}^{k} - {ζ}_{NR} Δ {v}_{L}^{k}$$

and the liquid phase

$${v}_{L}^{k + 1} ← {v}_{L}^{k} + {ζ}_{NR} Δ {v}_{L}^{k} .$$

Step 7. Check for convergence. If

$${max}_{i \leq {N}_{c}} \{ \vert {F}_{i} \vert \} < {ε}_{F} ,$$

then stop. Otherwise, k←k+1 and return to step 3. In this Example, ε_{F} is set to 10⁻¹⁰.

Initial guess. Raoult's law does not give accurate K values as the initial guesses for stability and phase-split calculation in this research. Also, N₂ and water are strongly immiscible; therefore, a specific initial estimation for K values is possible as presented in this subsection. The index i=1 is defined as the component index for water. To search for an incipient aqueous phase, an initial guess for the composition is xᵢ=10⁻⁹ for i=2, . . . , N_{C}, and x₁=1.0−(N_{C}−1)×10⁻⁹. The molar volume is set to

$$\underline{V} = max ( 18 \times 1 {0}^{- 6} , 1 + 1 {0}^{- 4} b ( x ) ) \qquad ( 39 )$$

to search for an incipient aqueous phase. To search for an incipient vapor phase, an initial guess for the composition is xᵢ=zᵢ/t for i=2, . . . , N_{C} and x₁=10⁻⁹/t, where

$$t = 1 {0}^{- 9} + {\sum }_{j = 2}^{{N}_{c}} {z}_{j} .$$

The molar volume is set to

$$V = {V}_{total} / ( 1. - {z}_{1} ) \qquad ( 40 )$$

to search for an incipient vapor phase.

The initial guess composition for the phase-split calculation is the same as that described elsewhere if the Hessian of the reduced Helmholtz free energy is positive definite. However, the initial guess molar volumes are determined by solving V=β_{L}V_{L}+β_{V}V_{V} subject to P_{L}=P_{V} using a Newton-Raphson algorithm. The algorithm is as follows:

Step 1. Set P^{k}←10 bar and k←1, Pₘᵢₙ←10⁻⁹, Pₘₐₓ←2×10⁻⁹

Step 2. Solve the EOS for the molar volume of liquid V_{L} and vapor V_{V} at the pressure P^{k}, and compute the derivative of pressure with volume for both phases. Compute the total volume Vₜ=V_{L}+V_{V}.
If Vₜ<Vₜₒₜₐₗ, set Pₘₐₓ←P^{k}. Otherwise, set Pₘᵢₙ←P^{k}.

Step 3. Update the pressure

$${P}^{k + 1} ← {P}^{k} - \frac{{V}_{t} - {V}_{total}}{\frac{\partial {V}_{L}}{\partial P} + \frac{\partial {V}_{V}}{\partial P}}$$

If |Vₜ−Vₜₒₜₐₗ|/Vₜₒₜₐₗ<10⁻⁷, the algorithm is converged. Use the liquid and vapor phase compositions and volumes as the initial guess to the flash calculation. Otherwise, set k←k+1 and return to Step 2.

If the Hessian of the reduced Helmholtz free energy is not positive definite, it is unconditionally unstable. The L-phase mole fraction and initial guess compositions are set as follows:

$${β}_{L} ← 1 {0}^{- 5} {\sum }_{j = 2}^{{N}_{c}} {x}_{i} + ( 1 - 1 {0}^{- 5} ) {x}_{1} , {x}_{i L} ← \frac{1 {0}^{- 5} {x}_{i}}{{β}_{L}} \\ where i = 2 , … , {N}_{c} , and$$

$${x}_{1 L} ← \frac{( 1 - 1 {0}^{- 5} ) {x}_{1}}{{β}_{L}} .$$

The V-phase mole fraction and initial guess compositions are set as follows:

$${β}_{V} ← ( 1 - 1 {0}^{- 5} ) {\sum }_{j = 2}^{{N}_{c}} {x}_{i} + 1 {0}^{- 5} {x}_{1} , {x}_{iV} = \frac{( 1 - 1 {0}^{- 5} ) {x}_{i}}{{β}_{V}} \\ where i = 2 , … , {N}_{c} , and$$

$${x}_{1 V} = \frac{1 {0}^{- 5} {x}_{1}}{{β}_{V}} .$$

The volumes of both phases are then computed using the Newton-Raphson algorithm above.

Application of the thermodynamic equilibrium model to aqueous nanobubble fluid with N₂. This section first describes experiments and results for aqueous NB fluids with N₂, and then presents the application of the thermodynamic equilibrium model to analyze the data. The modeling part includes calibration of the GERG-2008 EOS, water/gas interfacial tension model, and calculations of equilibrium properties of the aqueous NB fluid samples.

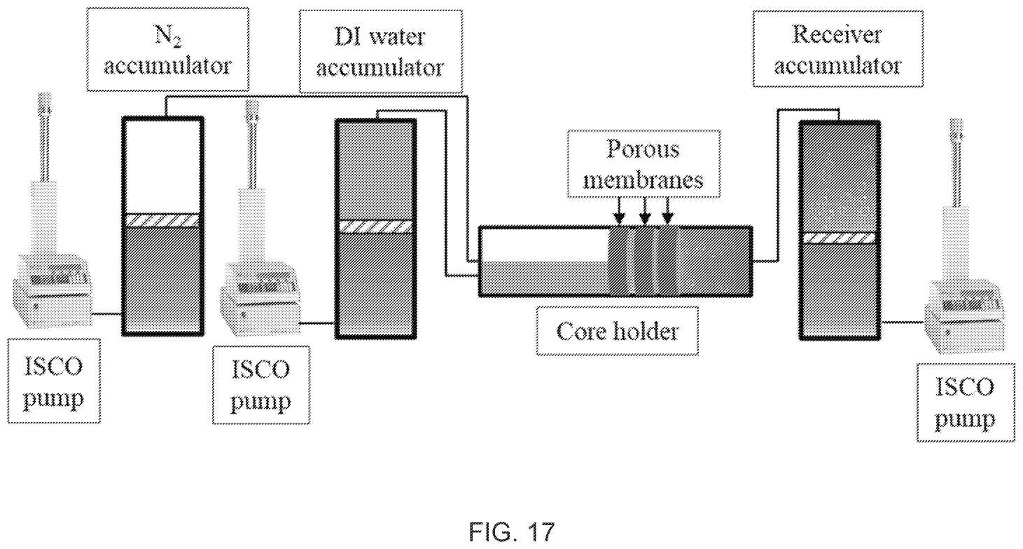

Generation of aqueous nanobubble dispersion of N₂ at elevated pressures. FIG. 17 shows a schematic for the experiment to generate aqueous NB fluid in this Example. Deionized (DI) water and high-purity N₂ gas were pressurized in accumulators equipped with a piston. They were co-injected at an equal volumetric rate of 50 cc/hr (in total, 100 cc/hr) at the test pressure into a core holder in which three porous stainless-steel membranes are placed. The confining pressure on the core holder was greater than the test pressure by 35 bar. Each membrane had a diameter of 1 inch and a thickness of 3 mm with homogeneous pores of 5 μm. One possible mechanism for such a porous membrane to generate aqueous NB dispersion is that as the water and gas flow through the pores, the hydrodynamic mixing and gas snap-off make dispersed gas bubbles in the aqueous phase that is supersaturated by the gas component. The water exiting from these three membranes then contains a greater amount of N₂ than the saturated amount because of two modes of dispersion: bubble dispersion as the internal phase and molecule dispersion in the external phase. The aqueous NB fluid prepared was then transferred into a receiver accumulator for storage at high pressure.

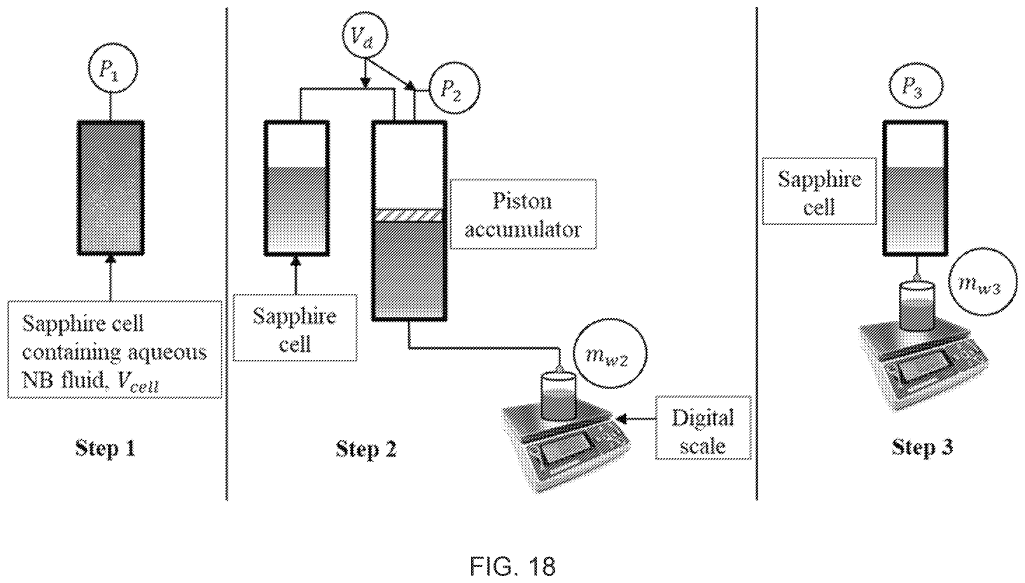

FIG. 18 shows a schematic for the experiment to measure the thermodynamic properties of aqueous NB fluid. Following the procedure given previously, the aqueous NB fluid sample was transferred from the receiver accumulator into a sapphire cell at pressure P₁. The sapphire cell provides a viewing window to observe the behavior of the aqueous NB fluid and it can withstand pressures up to 350 bar. The volume of the sapphire cell is known and denominated as V_{cell}. Then, the cell was connected to the top side of an accumulator containing a piston and a pressure gauge. The piston was initially set at the top of the accumulator and the dead volumes (V_{d}) in the line connecting the sapphire cell to the accumulator as well as the line connecting the accumulator to the pressure gauge were evacuated. Next, the cell was gradually depressurized by opening the cell to fill the dead volumes with N₂ from the aqueous NB fluid. The bottom side of the accumulator was then opened to the atmosphere. Water was collected to gauge the displacement of the piston as the aqueous NB fluid sample was depressurized or expanded. The water collected corresponds to the volume of depressurized N₂ in the aqueous NB fluid. The mass of the water collected is denoted as m_{w2}, and the pressure at the top side of the accumulator after depressurization is P₂. Finally, the remaining water in the cell was collected and its mass m_{w3} was measured.

These experiments were performed in Austin, TX, in the week of Apr. 3, 2023. The average atmospheric pressure was 1.0135 bar during this period with a minimum of 1.000 bar and a maximum of 1.026 bar in Austin, Texas. This pressure was used as P₃ in the calculation. The temperature was recorded at 295.15 K for each measurement.

Analysis of aqueous NB fluid with N₂. This subsection first shows the application of the thermodynamic framework described earlier to analyze the experimental data for aqueous NB fluid with N₂, and to calculate an apparent radius of bubbles for each aqueous NB fluid sample. Although size distributions of nanobubbles have been measured and reported for low-pressure (mostly atmospheric pressure) samples in the literature by using light scattering, spectral, and high-resolution imaging techniques, such measurement for high-pressure aqueous NB sample is not an easy task, requiring a specific design for the high-pressure sample container used. The estimated bubble sizes in this section enable an understanding of the overall behavior of the aqueous NB fluid with N₂ from a thermodynamic viewpoint.

First, the data are analyzed by using the thermodynamic equilibrium model based on the following assumptions:
1. Data were measured at equilibrium.
2. The water mass measured in Step 3 (FIG. 18) was at equilibrium with the N₂ gas cap in the sapphire cell.
3. The mass of water left in the sapphire cell in the form of droplets on the interior was negligible in comparison to the mass measured m_{w3}.
4. The system was closed in the depressurizing process from P₂ to P₃.

As explained above, the phase equilibrium including capillary pressure can be specified by (N_{C}+3) variables; for example, temperature, total volume, total mole numbers of components, and capillary pressure. Here, the thermodynamic model is used for temperature, total volume, total mole numbers of components, and the external phase pressure, which are measurable (directly or indirectly) for aqueous NB fluid samples in this Example.

The procedure below first explains how to estimate the total mole numbers in the sapphire cell in Step 1 of the experiment (FIG. 18), and then how to determine the apparent radius of bubbles for the external phase pressure P₁.
Perform a flash calculation at P₃ (atmospheric pressure) and 295.15 K for an equimolar mixture of the water/N₂ binary system. The mixture is assumed to be equimolar only to obtain the equilibrium aqueous-phase composition in Step 3. The volume of the aqueous phase is calculated as V_{w3}=m_{w3}V_{L}/M_{L} where V_{L} and M_{L} are the equilibrium aqueous-phase molar volume and weight. The mole number for water in the aqueous phase is n_{w3}=m_{w3}/M_{L}=d_{1L}V_{w3}.
Perform a flash calculation at P₂ and 295.15 K. The total volume of the aqueous phase in Step 2 is V_{L2}=n_{w3}/d_{1L} where d_{1L} is the water molar density in the aqueous phase obtained.
Perform a flash calculation at P₃ and 295.15 K for a binary water/N₂ mixture where N₂ (as an approximate composition of air) is at equilibrium with the water collected in Step 2. The volume of water collected is therefore V_{w2}=m_{w2}V_{L}/M_{L} where V_{L} and M_{L} are the equilibrium aqueous-phase molar volume and weight. The total volume of the mixture at P₂ is therefore Vₜ₂=V_{cell}+V_{w2}+V_{d} where V_{d} is the dead volume contained in the line connecting the sapphire cell and the accumulator and the line connecting the accumulator to the pressure gauge.
Determine the total number of moles in the system between the sapphire cell and the accumulator which gives the liquid volume V_{L2} and the gas volume Vₜ₂−V_{L2}.
Perform flash calculations at the total volume V_{cell} and the mole numbers of water and N₂ with a bubble radius of 1 nm and 104 nm. If the external-phase pressure P₁ lies between the values for 1 nm and 104 nm, perform a bisection to find the bubble radius that gives the external-phase pressure P₁.

Table 9 shows the data measured in the experiment for aqueous NB fluids with N₂. Use of the data in Table 9 with the procedure given above yields a possible radius of bubbles for the temperature (295.15 K), total volume (V_{cell}), mole numbers for water (n_{w}) and N₂ (n_{N}_{₂}), and external-phase pressure (P₁). Among these input parameters, m_{w3} is the most uncertain and found to be influential to the resulting bubble radius in the calculation. Table 9 shows that the uncertainty of m_{w3} is ±3 g. For example, if m_{w3} was smaller by 0.1 g, it could increase the calculated apparent radius of bubbles by one order of magnitude. Therefore, it was not possible to quantitatively determine an apparent radius of bubbles for these data with an order-of-magnitude accuracy only by using thermodynamic calculation. Nonetheless, the existence of bubbles with a realistic apparent radius for the actual experimental conditions indicates the possibility of thermodynamic aqueous NB fluid, in which the gaseous component is dispersed molecularly and also as bubbles in the external aqueous phase with capillary pressure.

TABLE 9
Experimental data used in the calculation
of aqueous NB of N₂ at 295.15K.

| Parameter | P₁ | P₂ | P₃ | m_{w2} | m_{w3} | V_{cell} | V_{d} |
|---|---|---|---|---|---|---|---|
| Unit | bar | bar | bar | g | G | mL | mL |
| Exp. 1 | 34.59 | 1.22 | 1.013 | 4.54 | 10.765 ± 3 | 13.69 | 6.705 |
| Exp. 2 | 68.93 | 1.29 | 1.013 | 11.4 | 10.930 ± 3 | 13.69 | 6.705 |
| Exp. 3 | 104.2 | 1.15 | 1.013 | 23.58 | 11.405 ± 3 | 13.69 | 6.705 |
| Exp. 4 | 103.3 | 1.29 | 1.013 | 19.49 | 11.310 ± 3 | 13.69 | 6.705 |
| Exp. 5 | 103.4 | 1.29 | 1.013 | 21.22 | 11.295 ± 3 | 13.69 | 6.705 |
| Exp. 6 | 138.2 | 1.22 | 1.013 | 32.01 | 11.040 ± 3 | 13.69 | 6.705 |
| Exp. 7 | 207.8 | 1.22 | 1.013 | 57.41 | 11.835 ± 3 | 13.69 | 6.705 |
| Exp. 8 | 277.1 | 1.22 | 1.013 | 71.92 | 12.040 ± 3 | 13.69 | 6.705 |

To analyze the experimental data, the thermodynamic equilibrium model was solved for the overall composition of the water/N₂ binary system at the specified temperature, the total molar volume, and the bubble radius. Since the mass of water collected from the sapphire cell m_{w3} was relatively uncertain, the thermodynamic calculation was repeated for multiple values of m_{w3} for each experiment within the range of possible values as shown in Table 9. For each calculation, the mole number for water n_{w} and the L-phase volume was adjusted based on m_{w3}. The mole number for nitrogen n_{N}_{₂} was based on the V-phase volume in Step 2, using the mass of water collected from the receiver accumulator m_{w2} from Table 9. The radius of bubbles was then determined for a system specified at fixed T, n_{N}_{₂}, n_{w}, V_{cell}, and P_{L}.

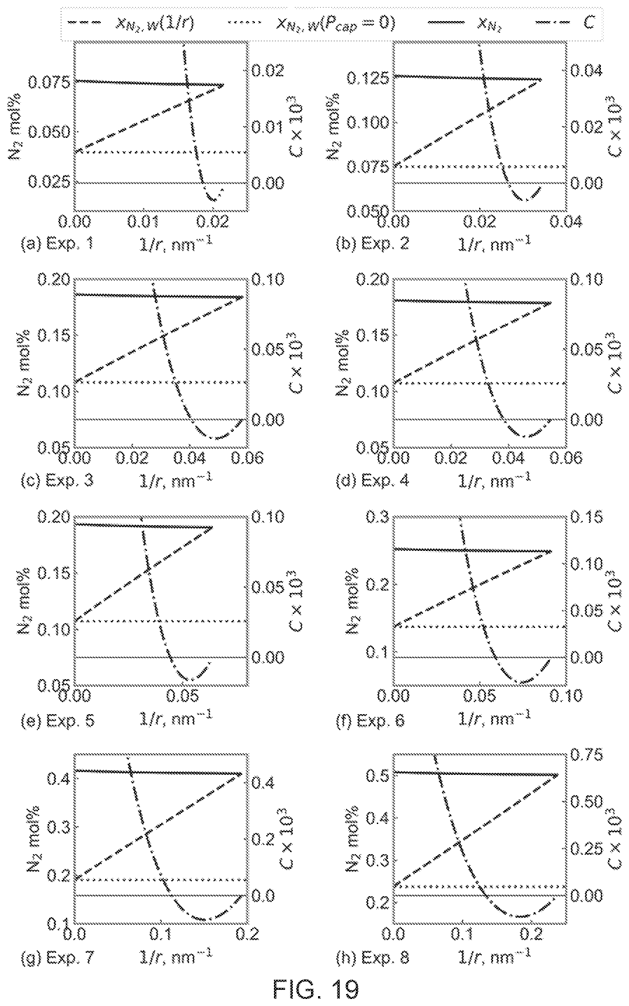

FIG. 19 shows the overall N₂ mole fraction z_{N}_{₂} with a bold black line, the mole fraction of N₂ in the aqueous phase x_{N}_{_{2,}}_{w} with a black dashed line, and that in the absence of capillary pressure x_{N}_{_{2,}}_{W}(P_{C}=0) with a dotted line for varying radius of bubbles. The stability criterion C(=D−ε. See equation 21) is plotted for the secondary y-axis with a black dash-dotted line. The radius of bubbles at which C=0 is the minimum radius that meets the stability criterion. The minimum radius of bubbles was calculated as 60.8 nm for FIG. 19, Panel a (Exp. 1 at 34.59 bar), 39.1 nm for FIG. 19, Panel b (Exp. 2 at 68.93 bar), 25.4 nm for FIG. 19, Panel c (Exp. 3 at 104.2 bar), 27.0 nm for FIG. 19, Panel d (Exp. 4 at 103.3 bar), 23.3 nm for FIG. 19, Panel e (Exp. 5 at 103.4 bar), 16.5 nm for FIG. 19, Panel f (Exp. 6 at 138.2 bar), 8.54 nm for FIG. 19, Panel g (Exp. 7 at 207.8 bar), and 7.14 nm for FIG. 19, Panel h (Exp. 8 at 277.1 bar). Table 10 presents n_{N}_{₂} and n_{w}, and the respective mass of N₂ and water used for the calculations with the datasets Exp. 1-8.

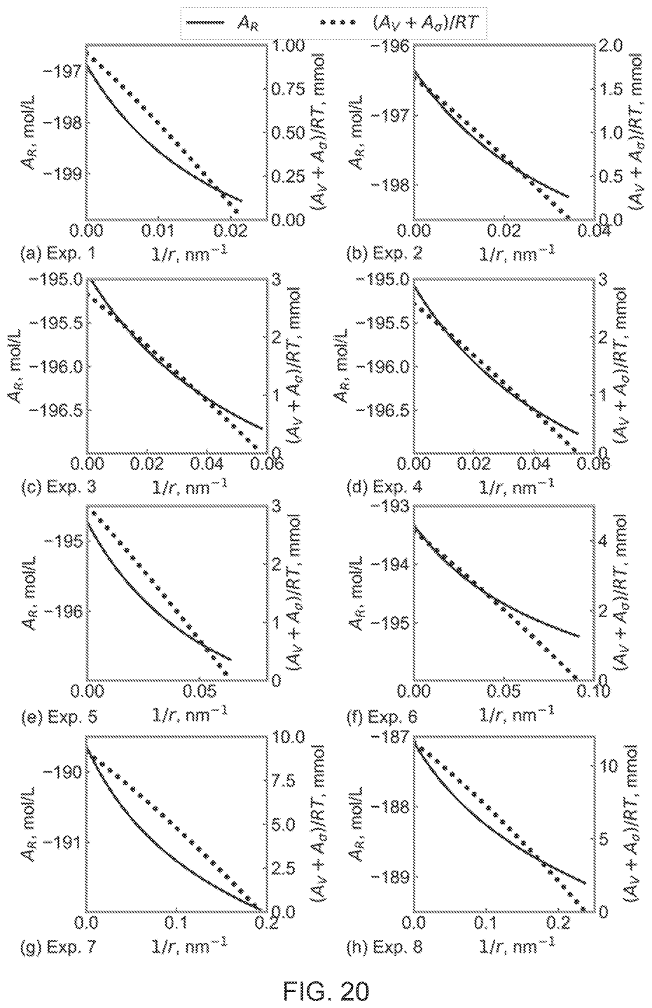

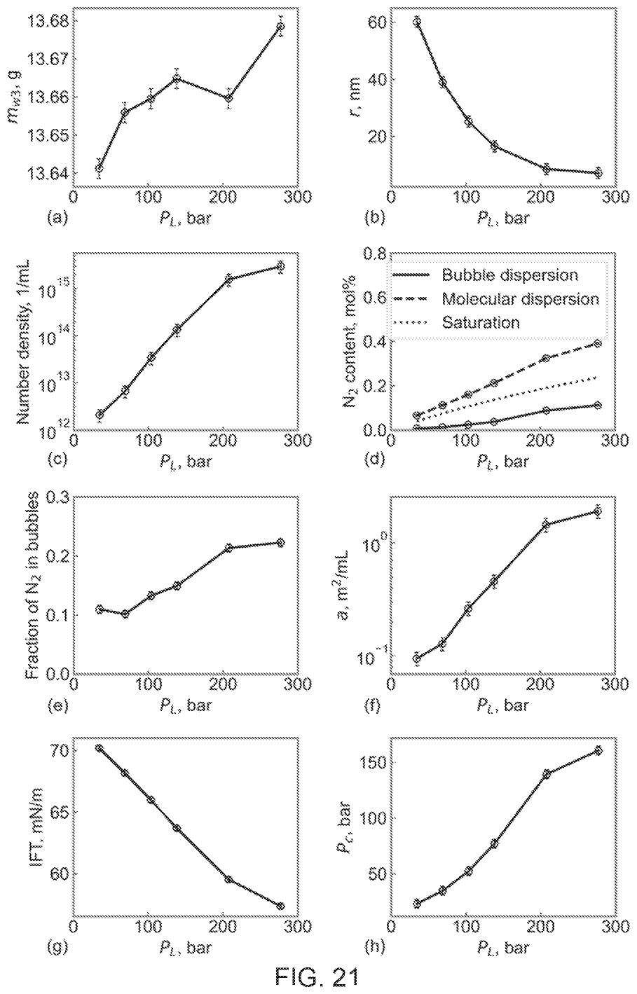

FIG. 20 shows the total reduced Helmholtz free energy using a bold black line and the total Helmholtz free energy of the vapor phase and the interface plotted for the secondary y-axis using a dotted line. For all the experimental data, the free energies monotonically decrease with decreasing bubble radii. That is, the overall composition that corresponds to C=0 results in the smallest possible Helmholtz free energy of the aqueous NB fluid with N₂ for a given temperature, total molar volume, and external-phase pressure based on the thermodynamic equilibrium model and the experimental data in this Example.

TABLE 10
Bubble radii, component moles and mass at C = 0
for each experiment at 295.15 K and a volume of 13.69 mL.

Parameter

| | r | n_{N}_{₂} | n_{w} | m_{N}_{₂} | m_{w} |
|---|---|---|---|---|---|
| Unit | nm | mol | mol | g | G |
| Exp. 1 | 60.18 | 0.5594 | 0.7572 | 0.01567 | 13.64 |
| Exp. 2 | 39.00 | 0.9447 | 0.7580 | 0.02646 | 13.66 |
| Exp. 3 | 25.33 | 1.401 | 0.7583 | 0.03924 | 13.66 |
| Exp. 4 | 26.98 | 1.362 | 0.7584 | 0.03814 | 13.66 |
| Exp. 5 | 23.21 | 1.451 | 0.7581 | 0.04065 | 13.66 |
| Exp. 6 | 16.52 | 1.898 | 0.7586 | 0.05316 | 13.67 |
| Exp. 7 | 8.542 | 3.136 | 0.7583 | 0.08785 | 13.66 |
| Exp. 8 | 7.147 | 3.843 | 0.7594 | 0.1076 | 13.68 |

To give an overview of the calculated properties of the aqueous NB fluid samples in this Example, an apparent radius of bubbles was calculated for the overall composition that corresponds to C=0 for each pressure for each aqueous NB fluid sample by using the thermodynamic equilibrium model. Once a radius of bubbles is set, the model gives various equilibrium properties of the aqueous NB fluid samples. FIG. 21, Panel a shows that the mass of water m_{w3} used for calculation at each pressure is within the uncertainty as given in Table 9. FIG. 21 also shows the bubble radius, bubble number density, the amount of N₂ in the bubbles, and the amount of N₂ that is molecularly dissolved in the external aqueous phase, total interfacial area, IFT, and capillary pressure with respect to the external (aqueous) phase pressure (P_{L}). The N₂ contents in FIG. 21, Panel d were calculated as x_{N}_{₂}_{V}β_{V} for the gas and x_{N}_{₂}_{L}β_{L} for the liquid water phase, where β_{V} is the vapor-phase mole fraction (as a total of bubbles) and β_{L} is the aqueous-phase mole fraction. The dotted line denoted as “Saturation” represents x_{N}_{₂}_{L}β_{L} when the N₂ and water are at equilibrium with no bubbles and therefore with a single planar interface between two bulk phases in the system. FIG. 21, Panel e shows the fraction of N₂ contained in bubbles calculated as x_{N}_{₂}_{V}β_{V}/z_{N}_{₂}. The error bars are determined as half the difference between the smallest and largest values at 104 bar since the experiment was repeated three times as Exp. 3, 4, and 5.

FIG. 21, Panels b and c show that the calculated radius and number density of bubbles decrease with increasing P_{L}. The extrapolation to atmospheric pressure using the two data points at the lowest pressure yields a bubble radius of 80 nm and a number density of 10⁹ per mL. This extrapolated radius lies within the range of measured bubble radii, 25-200 nm, at atmospheric pressure. Likewise, the extrapolated number density is within the range of measured values, 10⁶-10⁹ mL⁻¹, at atmospheric pressure.

FIG. 21, Panels d and e show that a large fraction of the N₂ in the system is molecularly dissolved in the external aqueous phase. This is a valuable finding from this research; that is, the existence of bubbles increases the N₂ content in the system by increasing the molecule dispersion (supersaturation) in the aqueous phase much more than by containing N₂ as bubbles. The presence of bubbles in aqueous NB fluid at equilibrium tends to increase the level of supersaturation in the external aqueous phase with capillary pressure. The results indicate that this supersaturation is the main contribution to the amount of N₂ in the aqueous NB fluid. Because the gas content is one of the most fundamental properties of aqueous NB fluid, this insight gained by the thermodynamic equilibrium model in this Example has fundamental impacts on the research and development of NB technologies, such as devices and applications to surface and subsurface processes.

Previous studies speculated that the IFT between the external aqueous phase and the gas bubbles depends on the bubble size. The thermodynamic equilibrium model developed in this research naturally predicts the size-dependent interfacial tension because of the thermodynamic relationships among variables, such as phase compositions, pressures, surface area, and interfacial tension, as shown in FIG. 21.

Conclusions. This Example presented the thermodynamic equilibrium model for aqueous NB fluid using the GERG-2008 EOS. The model was applied to experimental data for aqueous NB dispersion of N₂ at pressures up to 277 bara (4019 psia) at 295.15 K (71.6° F.). Thermodynamic analysis of the experimental data yielded the following conclusions:
A thermodynamic system of aqueous NB fluid is possible if gas bubbles are dispersed in the external aqueous phase that is supersaturated by the gaseous species with no bulk gas phase. The bubble nucleation criterion derived in this Example indicates that the thermodynamic stability of aqueous NB fluid requires a minimum amount of gaseous species in the system.
Application of the thermodynamic model to the high-pressure experimental data showed that the aqueous NB fluid system gives the smallest possible Helmholtz free energy at the overall composition corresponding to the gas-bubble nucleation limit for a given temperature, total volume, and radius of bubbles.
As the experimental data showed, the amount of gas in the aqueous NB fluid increased with increasing pressure of the external aqueous phase. Accordingly, the model indicated that the bubble radius decreased and the bubble number density increased with increasing pressure of the aqueous phase. The extrapolation to atmospheric pressure yielded a bubble radius of 80 nm and a number density of 10⁹ mL⁻¹, which are within the range of data measured at atmospheric pressure.
The analysis of the data indicated that a large fraction (0.8-0.9) of the gaseous species, N₂, in the system was molecularly dissolved in the aqueous phase. Hence, the existence of bubbles was important to increase the level of N₂ supersaturation in the aqueous phase, but the amount of N₂ as bubbles was not the main contribution to the total amount of N₂ in the aqueous NB fluids in this Example.
The thermodynamic equilibrium model developed in this Example naturally predicts that the IFT between the external aqueous phase and the gas bubbles depends on the bubble size because of the thermodynamic relationships among variables, such as phase compositions, pressures, surface area, and interfacial tension.

Figure captions for Example 2.

FIG. 13. Equilibrium mole fractions of water in the vapor phase and nitrogen in the aqueous phase; (Panel a) shows water mole fraction in the vapor phase at 273.15 K, 283.15 K, 323.15 K, and 422.4 K from bottom to top; (Panel b) shows nitrogen mole fractions in the aqueous phase at 323.15 K and 298.15 K from bottom to top. The hollow squares and the dotted lines respectively show the equilibrium mole fractions calculated using REFPROP (RPGERG) and the implementation of GERG (TGRGERG) developed here. The solid lines show the calibrated GERG model, for which the tuned parameters are shown in Tables 1 and 2.

FIG. 14. Calibrated pseudo-covolume for water/N₂. The hollow red circles show the molar volume root for a pressure of 2×10⁷ bar. The dark dashed and bold lines respectively show the matched co-volume using the geometrical mixing rule and the reference mixing rule for a BIP of 0. The dotted line represents the matched pseudo-covolume using the GERG-type mixing rule.

FIG. 15. Calibrated Parachor model for IFT of water and nitrogen at various temperatures and pressures. Experimental data are shown by black circles at 298.15 K, red squares at 313.15 K, blue diamonds at 333.15 K, green triangles 353.15 K, and yellow downward triangles at 373.15 K.

FIG. 16. The temperature-dependent coefficient χ for the modified Parachor model in this Example.

FIG. 17. Schematic of the experimental setup used to generate aqueous NB fluid.

FIG. 18. Schematic of the experimental setup to measure the thermodynamic properties of the aqueous NB fluid.

FIG. 19. Solutions of the thermodynamic equilibrium model for the aqueous NB fluid samples for Exp. 1-Exp. 8. The secondary y-axis is the stability criterion C=D−ϵ (see equation 21) multiplied by 10³.

FIG. 20. Reduced total Helmholtz free energies [A_{R} and (A_{V}+A_{σ})/RT] for the aqueous NB fluids with N₂ at 295.15 K for Exp. 1 through Exp. 8.

FIG. 21. Mass of water in the sapphire cell, bubble radius, bubble number density, N₂ content, fraction of N₂ in bubbles, interfacial area, interfacial tension and capillary pressure of N₂ in water for nanobubble solutions at 295.15 K for Exp. 1 through Exp. 8.

FIG. 22. Flow chart for the flash calculation algorithm.

### REFERENCES

U.S. Pat. Nos. 2,875,833, 3,800,874, and 6,325,147.
U.S. Patent Publication No. 2009/0000193.
PCT International Application Publication Nos. WO 2010/018844, WO 2011/019053, WO 2012/133265, WO 2007/124471, WO 2008/058298, and WO 2022/054326.
Achour S. H., 2023. Modeling of Multiphase Multicomponent Transport in Tight Porous Media. Ph.D. Dissertation, The University of Texas at Austin.
Achour, S. H. and Okuno, R., 2020. Phase Stability Analysis for Tight Porous Media by Minimization of the Helmholtz Free Energy. Fluid Phase Equilibria, 520: 112648. doi: 10.1016/j.fluid.2020.112648
Achour, S. H. and Okuno, R., 2021. Two-Phase Flash for Tight Porous Media by Minimization of the Helmholtz Free Energy. Fluid Phase Equilibria, 534: 112960. doi: 10.1016/j.fluid.2021.112960
Alheshibri, M., Qian, J., Jehannin, M., and Craig, V. S. J. 2016. A history of nanobubbles. Langmuir, Vol. 32, Issue 32, pp. 11086-11100.
Aursand, P., Gjennestad, M. A., Aursand, E., Hammer, M. and Wilhelmsen, Ø., 2016. The Spinodal of Single- and Multi-Component Fluids and its Role in the Development of Modern Equations of State. Fluid Phase Equilibria, 436, 98-112. doi: 10.1016/j.fluid.2016.12.018
Azevedo, A., Oliveira H. and Rubio, J. 2019. Bulk nanobubbles in the mineral and environmental areas: updating research and applications. Advances in Colloid and Interface Science, Vol. 271, 101992.
Bikkina, P. K., Shoham, 0, and Uppaluri, R., 2011. Equilibrated Interfacial Tension Data of the CO₂-Water System at High Pressures and Moderate Temperatures. Journal of Chemical & Engineering Data, 56(10): 3725-3733. doi: 10.1021/je200302h
Bisweswar, G., Al Hamairi, A., and Jin, S., 2020. Carbonated water injection: an efficient EOR approach. A review of fundamentals and prospects. J. Petrol. Explor. Prod. Technol., 10, pp. 673-685.
Chen, X., Kianinejad, A., and DiCarlo, D. 2016. Measurements of CO2-brine relative permeability in Berea sandstone using pressure taps and a long core. Greenhouse Gases: Science and Technology, Vol. 7, pp. 370-382.
Favvas, E. P., Kyzas, G. Z., Efthimiadou, E. K., and Mitropoulos, A. 2021. Bulk nanobubbles, generation methods and potential applications. Current Opinion in Colloid & Interface Science, Vol. 54, 101455.
Fechter, T., Villablanca, R., Leontijevic, V., Martin, A., Jaeger, P. and Cocero, M. J., 2023. Interfacial Tension of Water Near to Critical Conditions by Using the Pendant Drop Method: New Experimental Data and a Correlation Based on the Parachor Method. The Journal of Supercritical Fluids, 196, 105899. doi: 10.1016/j.supflu.2023.105899
Gernert, J. and Span, R., 2016. EOS-CG: A Helmholtz Energy Mixture Model for Humid Gases and CCS Mixtures. The Journal of Chemical Thermodynamics, 93, 274-293. doi: 10.1016/j.jct.2015.05.015
Hiramoto, H., Kukuu, K., Kurihara, M., Akai, T., Takakuwa, Y., Sato, K., Tsuchiya, Y., Araki, N., and Shirai, S., 2016. Experiments of Micro-bubble CO₂ EOR Using Berea Sandstone Core Samples, 22nd Formation Eval. Symp. Japan, Sep. 29-30, 2016.
Iguchi, M., Kaji, M., and Morita, Z. 1998. Effects of pore diameter, bath surface pressure, and nozzle diameter on the bubble formation from a porous nozzle. Metallurgical and Materials Transactions B, vol. 29B, pp. 1209-1218.
Imre, A. R., Baranyai, A., Deiters, U. K., Kiss, P. T., Kraska, T. and Quinones Cisneros, S. E., 2013. Estimation of the Thermodynamic Limit of Overheating for Bulk Water from Interfacial Properties. International Journal of Thermophysics, 34, 2053-2064. doi: 10.1007/s10765-013-1518-8
Jadhav, A. J., and Barigou, M., 2020. Bulk Nanobubbles or Not Nanobubbles: That is the Question, Langmuir, 36, pp. 1699-1708.
Kaptay, G., 2012. The Gibbs Equation Versus the Kelvin and the Gibbs-Thomson Equations to Describe Nucleation and Equilibrium of Nano-Materials. Journal of nanoscience and nanotechnology, 12(3), 2625-2633. doi: 10.1166/jnn.2012.5774
Ke, S., Xiao, W., Quan, N., Dong, Y., Zhang, L., and Hu, J., 2019. Formation and Stability of Bulk Nanobubbles in Different Solutions, Langmuir, 35, pp. 5250-5256.
Kontogeorgis, G. M. and Folas, G. K. 2009. Thermodynamic Models for Industrial Applications: From Classical and Advanced Mixing Rules to Association Theories, Wiley. doi: 10.1002/9780470747537
Kukizaki, M. and Goto, M. 2006. Size control of nanobubbles generated from Shirasu-porous-glass (SPG) membranes. Journal of Membrane Science, Vol. 281, pp. 386-396.
Kunz, O. and Wagner, W., 2012. The GERG-2008 Wide-Range Equation of State for Natural Gases and Other Mixtures: an Expansion of GERG-2004. Journal of Chemical & Engineering Data, 57(11), 3032-3091. doi: 10.1021/je300655b
Lawal, T., Argüelles-Vivas, F. J., Huh, C., and Okuno, R., 2022. Properties of Gas-Containing Water. Presentation at the 1^{st} Annual Workshop, the Energi Simulation Industrial Affiliate Program on Carbon Utilization and Storage, June 13-14, Austin, Tx.
Lemmon, E. W., Heinemann, V., Lu, J., Bell, I., 2017. Version 2.0 of Routines for the Calculation of Thermodynamic Properties from the AGA 8 Part 2 GERG-2008 Equation of State. Retrieved from https://github.com/usnistgov/AGA8
Lemmon, E., Bell, I., Huber, M., Harvey, A., McLinden, M., 2018. NIST Reference Fluid Thermodynamic and Transport Properties Database (REFPROP) Version 10-SRD 23. doi: 10.18434/T4/1502528
Li, M., Ma, X., Eisener, J., Pfeiffer, P., Ohl, C., and Sun, C., 2021 How bulk nanobubbles are stable over a wide range of temperatures, J. Colloid Interface Sci., 596, pp. 184-196.
Li, X., Peng, B., Liu, Q., Liu, J., and Shang, L. 2023. Micro and Nanobubbles Technologies as a New Horizon for CO₂-EOR and CO₂ Geological Storage Techniques: A Review. Fuel 341: 127661. doi: 10.1016/j.fuel.2023.127661
Manning, G. S. 2020. On the thermodynamic stability of bubbles, immiscible droplets, and cavities. Physical Chemistry Chemical Physics, Vol. 22, pp. 17523-17531.
Michailidi et al., 2020, Bulk nanobubbles: Production and investigation of their formation/stability mechanism, J. Colloid and Interface Science, 564, 371-380 doi: 10.1016/j.jcis.2019.12.093
Michelsen, M. L., 1982. The Isothermal Flash Problem. Part II. Phase-Split Calculation. Fluid Phase Equilibria, 9(1): 21-40. doi: 10.1016/0378-3812(82)85002-4
Mikyška, J. and Firoozabadi, A., 2011. A New Thermodynamic Function for Phase-Splitting at Constant Temperature, Moles, and Volume. AIChE Journal, 57(7): 1897-1904. doi: 10.1002/aic.12387
Nirmalkar, N., Pacek, A. W., and Barigou, M., 2018. On the Existence and Stability of Bulk Nanobubbles. Langmuir, 34(37): 10964-10973. doi: 10.1021/acs.langmuir.8b01163
Oh, S. H., and Kim, J. M., 2017. Generation and Stability of Bulk Nanobubbles. Langmuir, 33(15): 3818-3823. doi: 10.1021/acs.langmuir.7b00510
Ohgaki, K., Khanh, N. Q., Joden, Y., Tsuji, A., and Nakagawa, T. 2010. Physicochemical approach to nanobubble solutions. Chemical Engineering Science, Vol. 65, pp. 1296-1300.
Okuno, R., Johns, R., and Sepehrnoori, K., 2010. A New Algorithm for Rachford-Rice for Multiphase Compositional Simulation. SPE Journal, 15(2): 313-325. doi: 10.2118/117752-PA
Robinson, D. B. and Peng, D. Y., 1978. The Characterization of the Heptane and Heavier Fractions for GPA Peng-Robinson Programs. Gas Processors Association Research Report. Tulsa, Oklahoma.
Schechter, D. S., and Guo, B., 1998. Parachors Based on Modern Physics and Their Uses in IFT Prediction of Reservoir Fluids. SPE Reservoir Evaluation & Engineering, 1(3): 207-217. doi: 10.2118/30785-PA
Snæbjörnsdóttir et al. 2020. Carbon Dioxide Storage Through Mineral Carbonation. Nature Reviews Earth & Environment, 1: 90-102. doi: 10.1038/s43017-019-0011-8
Talebi, A., Hasan-Zadeh, A., Kazemzadeh, Y., and Riazi, M., 2022. A review on the application of carbonated water injection for EOR purposes: Opportunities and challenges, J. Petrol. Sci. Eng., 214, 110481.
Tan, B. H., An, H., and Ohl, C., 2020. How bulk nanobubbles might survive, Phys. Rev. Lett., 124, 134503.
Terasaka, K., Yasui, K., Kanematsu, W., and Aya, N. 2021. Ultrafine Bubbles. Jenny Stanford Publishing, New York. doi: 10.1201/9781003141952
Ulatowski, K., Sobieszuk, P., Mróz, A., and Ciach, T. 2019. Stability of nanobubbles generated in water using porous membrane system. Chemical Engineering & Processing: Process Intensification. Vol. 136, pp. 62-71.
Ushikubo, F. Y., Furukawa, T., Nakagawa, R., Enari, M., Makino, Y., Kawagoe, Y., Shiina, T., and Oshita, S. 2010. Evidence of the existence and the stability of nano-bubbles in water. Colloids and Surfaces A: Physicochemical and Engineering Aspects, Vol. 361, pp. 31-37.
Varzandeh, F., Stenby, E. H., and Yan, W. 2017. Comparison of GERG-2008 and Simpler EoS Models in Calculation of Phase Equilibrium and Physical Properties of Natural Gas Related Systems. Fluid Phase Equilibria, 434: 21-43.
Ward, C. A., Tikuisis, P., and Venter, R. D. 1982. Stability of bubbles in a closed volume of liquid-gas solution. Journal of Applied Physics, Vol. 53, p. 6076.
Weijs, J. H., Seddon, J. R. T., and Lohse, D. 2012. Diffusive shielding stabilizes bulk nanobubble clusters. ChemPhysChem, Vol. 13, pp. 2197-2204.
Widiatmoko, P., Saputera, W. H., Devianto, H., Nurdin, I., Rivana, E., and Angkasa, A. 2021. Effect of Bubble Size on Electochemical Reduction of Carbon Dioxide to Formic Acid. IOP Conf. Series: Materials Science and Engineering, 1143: 012001. doi:10.1088/1757-899X/1143/1/012001
Wiebe, R., Gaddy, V. L., and Heins Jr., C. 1932. Solubility of nitrogen in water at 25 C from 25 to 1000 atmospheres. Industrial & Engineering Chemistry, Vol. 24, Issue 8, p. 927.
Xue, Z., Park, H., Ueda, R., Nakano, M., Nishii, T., and Inagaki, S., 2018. Microbubble CO2 Injection for Enhanced Oil Recovery and Geological Sequestration in Heterogeneous and Low Permeability Reservoirs, 14^{th} Intern. Conf. Greenhouse Gas Control Technol., Melbourne, Australia, Oct. 21-25, 2018.
Yan, W., Zhao, G. Y., Chen, G. J. and Guo, T. M., 2001. Interfacial Tension of (Methane+Nitrogen)+Water and (Carbon Dioxide+Nitrogen)+Water Systems. Journal of Chemical & Engineering Data, 46(6): 1544-1548. doi: 10.1021/je0101505
Zhang, H., Chen, S., Guo, Z., and Zhang, X., 2022. The fate of bulk nanobubbles under gas dissolution, Phys. Chem. Chem. Phys., 24, 9685.
Zhou, L., Wang, S., Zhang, L., and Hu, J., 2021. Generation and Stability of Bulk Nanobubbles: A Review and Perspective. Current Opinion in Colloid & Interface Science, 53: 101439. doi: 10.1016/j.cocis.2021.101439

### STATEMENTS REGARDING INCORPORATION BY REFERENCE AND VARIATIONS

All references throughout this application, for example patent documents, including issued or granted patents or equivalents and patent application publications, and non-patent literature documents or other source material are hereby incorporated by reference herein in their entireties, as though individually incorporated by reference.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure. As used herein, “and/or” means that one, all, or any combination of items in a list separated by “and/or” are included in the list; for example “1, 2, and/or 3” is equivalent to “1, 2, 3, 1 and 2, 1 and 3, 2 and 3, or 1, 2, and 3”.

Every formulation or combination of components described or exemplified can be used to practice the invention, unless otherwise stated. Specific names of materials are intended to be exemplary, as it is known that one of ordinary skill in the art can name the same material differently. It will be appreciated that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition, in a description of a method, or in a description of elements of a device, is understood to encompass those compositions, methods, or devices consisting essentially of and consisting of the recited components or elements, optionally in addition to other components or elements. The invention illustratively described herein suitably may be practiced in the absence of any element, elements, limitation, or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by examples, embodiments, and optional features, modification and variation of the concepts herein disclosed may be resorted to by those skilled in the art, and that such modifications and variations are considered to be within the scope of this invention as defined by the appended claims.

1. A method, comprising:
determining a target composition of an aqueous fluid for use in a nanobubble solution of a gas at a specified temperature and a specified pressure;
preparing the aqueous fluid according to the target composition;
mixing the gas in the aqueous fluid to establish a supersaturated solution of the gas in the aqueous fluid at the specified temperature and the specified pressure; and
subjecting the gas and the aqueous fluid to a bubble generation process to establish a dispersion of nanobubbles of the gas in the aqueous fluid at the specified temperature and the specified pressure.

2. The method of claim 1, wherein the gas is immiscible in the aqueous fluid or has a solubility in water of less than 2 g/L at standard temperature and pressure.

3. The method of claim 1, wherein the specified temperature is greater than 0° C. and less than a boiling point of the aqueous fluid at the specified pressure.

4. The method of claim 1, wherein the specified pressure is from 1 MPa to 105 MPa.

5. The method of claim 1, wherein the dispersion of nanobubbles of the gas in the aqueous fluid exhibits a supersaturation amount greater than that of the supersaturated solution of the gas in the aqueous fluid.

6. The method of claim 1, wherein the dispersion of nanobubbles of the gas in the aqueous fluid exhibits a higher intensity and/or faster kinetics of mineral dissolution and/or precipitation than the supersaturated solution of the gas in the aqueous fluid.

7. (canceled)

8. The method of claim 1, wherein the gas comprises a hydrocarbon gas suspended in or contained in an inert gas.

9. The method of claim 1, wherein the nanobubbles have diameters from 1 nm to 1000 nm.

10. The method of claim 1, wherein the dispersion of nanobubbles corresponds to a concentration of the gas in the aqueous fluid of from 0.05 mol/L to 20 mol/L.

11-13. (canceled)

14. The method of claim 1, wherein the aqueous fluid comprises one or more salts, one or more electrolytes, one or more acids, one or more bases, a monovalent anion, a monovalent cation, a divalent anion, a divalent cation, a trivalent anion, a trivalent cation, formate, or any combination of these.

15. The method of claim 1, wherein the aqueous fluid comprises an additive selected from a surfactant, a foaming agent, a polymer, nanoparticles, an alcohol, an oxygenated solvent, or any combination of these.

16-17. (canceled)

18. The method of claim 1, wherein determining the target composition of the aqueous fluid includes determining an ionic composition or ionic strength for the aqueous fluid.

19-20. (canceled)

21. The method of claim 1, wherein the bubble generation process comprises injecting the gas into the aqueous fluid through a porous membrane, coinjecting the gas and the aqueous fluid through a porous membrane, injecting the gas into the aqueous fluid through one or more nozzles, coinjecting the gas and the aqueous fluid through one or more nozzles, subjecting the supersaturated solution of the gas in the aqueous fluid to a pressure reduction to initiate bubble nucleation, subjecting the supersaturated solution of the gas in the aqueous fluid to ultrasonic energy, subjecting the supersaturated solution of the gas in the aqueous fluid to shear stress, or a combination of these.

22. The method of claim 1, wherein determining the target composition of the aqueous fluid includes determining a target pH for the aqueous fluid.

23. The method of claim 1, wherein determining the target composition of the aqueous fluid comprises providing at least the specified temperature, the specified pressure, and the identity of the gas to a thermodynamic model.

24. The method of claim 23, wherein the thermodynamic model determines properties of the dispersion including an amount of the gas present in the dispersion as the nanobubbles.

25. The method of claim 23, wherein determining the target composition of the aqueous fluid further comprises providing to the thermodynamic model identities of one or more salts, one or more electrolytes, one or more acids, one or more bases, or one or more additives for use in the aqueous fluid.

26-27. (canceled)

28. The method of claim 1, further comprising injecting the dispersion of nanobubbles into a subterranean reservoir.

29-30. (canceled)

31. The method of claim 28, wherein the dispersion of nanobubbles is subjected to a mineralization process in the subterranean reservoir to transform at least a portion of the gas to a solid mineral in the subterranean reservoir.

32. (canceled)

33. A carbon sequestration method, comprising:
preparing an aqueous fluid for use in a nanobubble solution of CO₂ in a subterranean reservoir;
mixing CO₂ in the aqueous fluid to establish a supersaturated solution of the CO₂ in the aqueous fluid;
subjecting the supersaturated solution to a bubble generation process to establish a dispersion of nanobubbles of the CO₂ in the aqueous fluid, wherein the dispersion of nanobubbles of the CO₂ in the aqueous fluid exhibits a supersaturation amount greater than that of the supersaturated solution of the CO₂ in the aqueous fluid; and
injecting the dispersion of nanobubbles of the CO₂ in the aqueous fluid into the subterranean reservoir, wherein the dispersion of nanobubbles of the CO₂ in the aqueous fluid is subjected to a mineralization process in the subterranean reservoir to transform at least a portion of the CO₂ injected into the subterranean reservoir to a carbonate mineral in the subterranean reservoir.

34-35. (canceled)
